(19) United States
(12) Patent Application Publication
(10) Pub. No.: US 2025/0032219 A1
(43) Pub. Date: Jan. 30, 2025

(54) PALATAL EXPANDER APPARATUSES AND METHODS USING CONE BEAM TOMOGRAPHY

(71) Applicant: Align Technology, Inc., San Jose, CA (US)

(72) Inventors: Jun SATO, San Jose, CA (US); Jeremy RILEY, Mountain View, CA (US); Ryan KIMURA, San Jose, CA (US)

(21) Appl. No.: 18/786,415

(22) Filed: Jul. 26, 2024

Related U.S. Application Data
(60) Provisional application No. 63/516,132, filed on Jul. 27, 2023.

(51) Int. Cl. A61C 7/02; A61C 7/00; A61C 7/10

(52) U.S. Cl. CPC A61C 7/023; A61C 7/002; A61C 7/10

(57) ABSTRACT

Methods for designing and fabricating palatal expanders by modeling expansion of the palatal region based on material properties for one or more regions of a maxillary jaw determined from a cone-beam computed tomography (CBCT) scan of the maxillary jaw and/or internal topological information for the maxillary jaw determined from the CBCT scan. Also described herein are series of palatal expanders having a sequence and configured to be sequentially worn by a patient to expand the patient's palate in which the left maxillary portion and the right maxillary portion are progressively separated relative to each other, and the thickness of the palatal region changes.

### CLAIM OF PRIORITY

This application claims priority to U.S. Provisional Patent Application No. 63/516, 132, titled “PALATAL EXPANDER APPARATUSES AND METHODS USING CONE BEAM TOMOGRAPHY,” filed on Jul. 27, 2023, and herein incorporated by reference in its entirety.

### BACKGROUND

A variety of orthodontic problems are linked with a narrow palate, including problems in tooth alignment and impairment of speech. In some cases the palate is so high that may limit the amount of air that can pass through the nose, so that deep breathing without opening the mouth is almost impossible. In all of these cases, palate expansion, that is separating and spreading the maxilla, may be helpful.

Typically, a palatal expansion device may be affixed to the upper posterior molars, sometimes with dental cement or adhesive. A screw mechanism may be employed to deliver a horizontal stretching force to the molars to stretch the palatal cartilage. In many cases, a large horizontal force is delivered by the orthodontist upon placement. This can cause headaches, nasal discomfort and pain. In other cases the screw or other mechanism is employed incrementally one or more times a day. While this incremental approach cases some of the discomfort of such devices, the incidence of discomfort remains high. Moreover, the devices are awkward and bulky, largely due to the mechanism. This bulkiness can cause difficulty with speech, swallowing and breathing. The screw or other mechanism can be difficult to operate and often involves use of a key which can be accidentally lost or swallowed, and may be difficult for users (including parents and caregivers) to operate correctly, and the manual nature of these mechanisms makes them susceptible to user error (e.g., turning the screw too little or too much, turning the screw in the wrong direction). In addition these devices tend to accumulate plaque.

Conventional palatal expanders may also fail to take into account the effects of the underlying anatomy specific to each patient, including skeletal information, and may instead rely primarily on topological information of teeth and the outer structure of the palatal region, while making assumptions about patient anatomy. Similarly, conventional palatal expanders are not designed to account for and address potential rotational movements of the maxilla or of the teeth during expansion, which may cause unintended problems with the final arrangement of the teeth.

Described herein are methods and apparatuses that may address these concerns.

### SUMMARY OF THE DISCLOSURE

Described herein are palatal expanders, methods of making and methods of using them. For example, described herein are palatal expanders, and in particular, series of palatal expanders, that are configured to provide incremental palatal expansion (including rapid or gradual palatal expansion) and methods of fabricating series of palatal expanders that are customized to a patient. These methods and apparatuses may use information on the patient-specific internal anatomy of the maxillary region, including the bones, bone local stiffness and material properties, etc. This information may allow the customization and optimization of the shape of each palatal expander as well as the overall staging patterns for palatal expansion of each patient. In general, these methods may allow integration of cone beam tomography (CBCT) into the design of the palatal expander. One principle innovation of the methods and apparatuses described herein is the integration of CBCT into the design workflow to utilize the topological information and possibly material properties to customize the palatal expander design and staging patterns.

The apparatuses (systems, devices, including software, firmware and hardware) and methods for expanding a patient's palate described herein are configured to use cone beam tomography (CBCT) to generate and optimize the palatal expander design and staging patterns. In particular, described herein are apparatuses and methods for generating a treatment plan including a plurality of stages for expanding a patient's palate, as well as dental appliances (e.g., palatal expanders, retainers, etc.) configured to perform these stages.

In particular, the methods and apparatuses described herein may set the thickness of the trans-palatal-arch (TPA) region of the dental appliance, and/or may position the center of expansion as part of the staging pattern for the dental appliances, based on information from one or more CBCT scans specific to the patient, if the scan is available. If the scan is not available, or is not of sufficient quality, the methods and apparatuses described herein may instead use predetermined values for the thickness and expansion plane (e.g., expansion center or an expansion axis through the expansion plane).

The methods and apparatuses described herein may use anatomical features from the internal maxillary structure, instead of or in addition to the arch-width and/or the palatal vault height to calculate the trans-palatal-arch (TPA) thickness and the position of the center(s) of expansion axes for configuring dental appliances corresponding to staging patterns of a treatment plan. For example, the methods and apparatuses described herein may use information from one or more penetrative scans, such as (but not limited to) CBCT scans, to customize the TPA thickness, and/or staging patterns which can optimize the palatal expander design for individual patients. In some examples, the thickness of the TPA and/or the center(s) of expansion axes for the dental appliance may be changed during the treatment plan. These changes may be based on the anatomical features from the internal maxillary structure as described herein. The patient's current skeletal expansion patterns may be determined based on the expansion amount of the intermolar width in the transverse direction and the skeletal lateral rotational axis.

For example, described herein are methods and apparatuses for designing one or more palatal expanders using CBCT data. A method of forming one or more palatal expanders may include: determining one or more material properties for one or more regions of a maxillary jaw; optionally determining internal topological information for the maxillary jaw from the CBCT scan; modeling expansion of a palatal region of the maxillary jaw from an initial position to an intermediate or final position using the one or more material properties for one or more regions of a maxillary jaw (and optionally the internal topological information), wherein a left maxillary portion of the maxillary jaw and a right maxillary portion of the maxillary jaw are progressively translated and rotated relative to their original positions; and building one or more palatal expanders configured to achieve the final position using the modeled expansion of the palatal region of the maxillary jaw.

The one or more material properties may be determined either from a cone-beam computed tomography (CBCT) scan of the maxillary jaw or from reference values (e.g., list, table, database, etc.). In any of these examples the method or apparatus may determine the one or more material properties (such as Young's modulus) form the reference values when the method or apparatus is unable to use a CBCT scan, otherwise the scan data may be used.

For example, described herein are methods of forming one or more palatal expanders, the method comprising; determining one or more material properties for one or more regions of a maxillary jaw from a cone-beam computed tomography (CBCT) scan of the maxillary jaw or a set of reference values; modeling expansion of a palatal region of the maxillary jaw from an initial position to an intermediate or final position using the one or more material properties for one or more regions of a maxillary jaw, wherein a left maxillary portion of the maxillary jaw and a right maxillary portion of the maxillary jaw are progressively translated and rotated relative to their original positions; and building one or more palatal expanders configured to achieve the final position using the modeled expansion of the palatal region of the maxillary jaw.

In any of these methods the methods may include a method of forming one or more palatal expanders comprising; determining one or more material properties for one or more regions of a maxillary jaw from a cone-beam computed tomography (CBCT) scan of the maxillary jaw; determining internal topological information for the maxillary jaw from the CBCT scan; modeling expansion of a palatal region of the maxillary jaw from an initial position to a final position using the one or more material properties for the for one or more regions of a maxillary jaw and the internal topography, wherein a left maxillary portion of the maxillary jaw and a right maxillary portion of the maxillary jaw are progressively translated (e.g., horizontally and/or vertically) and/or rotated relative to their original positions; and building one or more palatal expanders configured to achieve the final position using the modeled expansion of the palatal region of the maxillary jaw.

As used herein, building one or more palatal expanders may comprise forming one and/or a series of palatal expanders configured to be worn in a sequence to expand the palatal region of the maxillary jaw from the initial position to the final position. In some examples the palatal expander(s) may be formed digitally, as a digital model, chg., a three-dimensional (3D) digital model. In some examples the palatal expander(s) may be formed by synthesizing the palatal expanders and/or one or more molds of the patient's teeth and/or palate region from which the palatal expanders may be fabricated. In some examples the palatal expander(s) may be formed by direct fabrication (e.g., additive manufacturing). In some examples the palatal expander(s) may be formed by molding using one or more molds.

The material properties for one or more regions of a maxillary jaw may include the relative stiffness (and/or relative flexibility) of all or a plurality of sub-regions of a patient's maxillary jaw. These methods and apparatuses may include directly using scan (e.g., CBCT scan) data to estimate and/or approximate the Young's modulus for all or specific regions of the patient's jaw. In particular, the methods and apparatuses may determine the stiffness (Young's modulus) for sub-regions of the patient's jaw based on the CBCT scan data, including based on the density information (shading) of the CBCT scan data. In any of these methods, determining the one or more material properties may include determining a local Young's modulus for a plurality of regions of the maxillary jaw from the CBCT scan of the maxillary jaw. The regions of the maxillary jaw may include the regions in and around the palate, the teeth and/or the surrounding alveolar bone (e.g., maxillary alveolar bone). For example, determining the one or more material properties may comprise determining a local Young's modulus for a plurality of regions of the maxillary jaw from the CBCT scan of the maxillary jaw including a suture of the maxillary jaw.

The material properties may be determined from the CBCT scan data using a machine learning agent. In some examples one or more material properties for one or more regions of the maxillary jaw from a CBCT scan may be determined using a trained machine learning agent to determine the one or more material properties for the one or more regions of the maxillary jaw. For example, the trained machine learning agent may be trained on CBCT scans having corresponding Young's moduli. In some examples determining one or more material properties for one or more regions of the maxillary jaw from a CBCT scan may comprise applying a reference based on a density from the CBCT scan. The material properties estimated from the CBCT scan (e.g., young's modulus) may be used to design and improve the palatal region, and in particular the thickness of the palatal region, which may be varied based on the estimated forces to expand the palate at each stage. Thus, in any of these methods and apparatuses the thickness of the palatal region may be different over different regions and/or across different treatment stages (of a treatment plan).

In any of these methods and apparatuses, topological information may indicate the expansion plane (and/or expansion axis) within the palatal region from which expansion may be driven in order to optimize palatal expansion (e.g., by optimizing the direction, magnitude, and/or patterns of palatal expansion). Unlike prior art methods and apparatuses the expansion plane may be offset from a midline of the patient's palate. For example, the optimal expansion plane (and therefore the expansion axis) may be offset to the patient's left or right side, e.g., when the suture is offset from the midline of the patient's palate. In some examples, the vertical expansion patterns may vary from anterior to posterior, e.g., with a three-dimensionally slanted expansion axis.

In any of these methods and apparatuses, modeling may comprise progressively translating and rotating the left maxillary portion of the maxillary jaw and the right maxillary portion of the maxillary jaw relative to their original positions about a location of a suture within the maxillary jaw determined from the internal topological information, for example, when the location of the suture within the maxillary jaw is offset from a midline of a palate of the maxillary jaw.

Any of these methods and apparatuses may include determining a target moment to tip the teeth buccally based on the one or more material properties and the modeled expansion of the palatal region of the maxillary jaw, wherein building the one or more palatal expanders comprises configuring the one or more palatal expanders to apply the target moment. The target moment to tip the teeth buccally may be applied by configuring the dental appliance to apply a force to rotate (e.g., tip) the teeth in a desired direction.

Internal topological information about one or more internal structures may be determined for the maxillary jaw from one or more patient-specific CBCT scans. For example, the CBCT scan taken before treatment (or shortly after starting treatment) may be used to determine the location of one or more internal topographic feature. Internal topological features may include any internal feature. Examples of internal topographic features may include the median palatal suture (“suture”) within the maxillary jaw, the tooth root location, shape and/or orientation(s), the dimensions of the alveolar bone, the location and/or dimensions of the sinuses, etc. The internal topographic information may be used in any of these methods and apparatuses. For example, the apparatus may be configured to detect and analyze one or more internal topographic feature, including in particular the location of the suture and/or the number, shape and/or size of the teeth.

For example, any of these methods and apparatuses may include modeling expansion of the maxillary jaw (e.g., modeling expansion of the palatal region) by modeling the left maxillary portion of the maxillary jaw and the right maxillary portion of the maxillary jaw progressively translating and rotating relative to their original positions with respect to a plane through the suture. As described herein, the methods and apparatuses described herein may beneficially adjust the position and/or orientation of the plane through the suture specific to a particular patient. Rather than assume that the suture is symmetrically located within the maxillary jaw (e.g., at the midline), the methods and apparatuses may estimate or determine a position and/or orientation of the suture that is offset from the midline. This patient-specific suture position and/or orientation may be used to estimate a plane, axis, and/or point of expansion from which the expansion of the palatal region may proceed. The methods and apparatuses may, in some examples, change or update the position and/or orientation of the suture, and therefore the plane, axis and/or point of expansion, during the course of a treatment/treatment plan.

Any of these methods and apparatuses performing the methods may be configured to determine internal topological information for the maxillary jaw from the CBCT scan by determining dimensions of alveolar bone within the maxillary jaw and/or the dimensions, and positions of the tooth roots. As mentioned, in general, the topological information may be used to model expansion and therefore the design of the palatal expanders.

Modeling may be performed in any appropriate manner. In general, these methods and apparatuses may include modeling expansion of the palatal region of the patient's maxillary jaw. Expansion may be modeled using finite element modeling (e.g., applied clement modeling, discrete element modeling, etc.), finite difference method, etc. For example, modeling expansion of the palatal region of the maxillary jaw may include using the material properties and the internal topological information in a finite element analysis model. Modeling may include dividing the expansion of the palatal region of the maxillary jaw from the initial position to the final position into a plurality of discrete stages and wherein building the one or more palatal expanders comprises building a palatal expander corresponding to one or more of these stages. The modeling of the palatal region of the patient's maxillary jaw may use the structure of the patient's maxillary jaw. In some examples, modeling expansion of the palatal region may include modeling the palatal region from an intraoral scan of the maxillary jaw; the intraoral scan may be modified by the internal topological information as mentioned above, and/or by the material properties, such as the regional Young's modulus for the various regions or sub-regions of the maxillary jaw. The modeling may determine expansion of the palatal region and movement of the teeth (e.g., right side and left side), including rotation (e.g., tipping), based on various palatal expander properties, and may determine the force applied to achieve a desired movement, within an acceptable range of force. The desired movement may prevent or limit moments of one or more teeth that may result in defects such as root collisions, fenestrations, dehiscence, protrusions of teeth roots from alveolar bone, etc. Modeling may be iterative, adjusting the applied force(s) and/or the locations of the applied forces until these parameters result in expansion of the maxillary jaw while avoiding defects or undesirable tooth movement, and while maintaining the forces within acceptable parameters. The modeling may also be used reduce local stress concentration, local strain level, etc., on the patient's tissues or teeth, thus reducing the likelihood of medical complications. For example, the modeling may adjust the applied force(s) and/or the locations of the applied forces until local stress concentrations or local strain levels in the patient (e.g., across the teeth engaging the palatal expander and across the palate) are below a predetermined threshold. In some example, iterating the modeling step may include iterating to minimize rotation (e.g., tipping) of teeth within the maxillary jaw and/or maintaining the applied force(s) within preset ranges and/or preventing, avoiding or correcting defects.

The resulting modeling, e.g., the forces and location(s) applied, may be used to form one or more (e.g., a series) of palatal expanders configured to be worn to accomplish the palatal expansion. Unlike other methods and apparatuses for expanding a patient's palate, these methods and apparatuses may account for the material properties of the maxillary jaw (e.g., regions/sub-regional Young's modulus, density, etc.) and/or the location and orientation of the suture, specific to a patient. The use of material properties and internal topological information as described herein typically requires the use of digital resources (computer processing), but these techniques result in more efficient processing, which may allow the modeling to settle on an acceptable or optimal solution much more quickly than prior techniques. In general, these methods and apparatuses may include building the one or more palatal expanders using this more accurate modeling.

The methods and apparatuses described herein may adjust the thickness of a trans-palatal arch region of the one or more palatal expanders as part of the modeling, providing more precise and targeted control over the expansion. In some examples these methods may include adjusting the thickness of the trans-palatal arch region of the one or more palatal expanders based on the modeled expansion of the palatal region in order to achieve the modeled expansion of the palatal region. For example, a series of palatal expanders may have trans-palatal arch regions having different thicknesses between different palatal expanders of the series, as the force applied by the trans-palatal arch regions may be controlled over the course of the treatment, resulting in different thicknesses. In any of these examples, modeling expansion of the palatal region of the maxillary jaw from the initial position to the final position may include progressively translating and rotating the left maxillary portion of the maxillary jaw and the right maxillary portion of the maxillary jaw relative to an expansion plane that is offset relative to a midline through the palatal region.

The method and apparatuses described herein may generally be configured to build one or more palatal expanders. In some examples building may include fabricating the one or more palatal expanders, e.g., by a direct fabrication technique, including three-dimensional (3D) printing techniques. Alternatively or additionally, building the one or more palatal expanders may include generating a digital palatal expander. These methods may provide an output including a digital file that may be used to fabricate the one or more palatal expanders.

In some examples a method of forming one or more palatal expanders may include: determining internal topological information for the maxillary jaw from a cone-beam computed tomography (CBCT) scan, wherein the internal topological information comprises the location of a suture within the maxillary jaw; determining local Young's moduli for one or more regions of a maxillary jaw from a CBCT scan including the suture; modeling expansion of a palatal region of the maxillary jaw from an initial position to a final position using the one or more material properties for the for one or more regions of a maxillary jaw and the internal topological information, wherein a left maxillary portion of the maxillary jaw and a right maxillary portion of the maxillary jaw are progressively translated and rotated relative to their original positions with respect to a plane through the suture; building one or more palatal expanders configured to achieve the final position using the modeled expansion of the palatal region of the maxillary jaw.

Also described herein are palatal expanders and/or a series of palatal expanders formed as described herein. A series of palatal expanders may have a sequence in which the individual palatal expanders are intended to be worn to accomplish expansion of the palatal region. The use of the CBCT data to form the palatal expander and/or a sequence of sequentially-worn palatal expanders may result in individual palatal expanders and/or series of palatal expanders having specific features to more effectively and efficiently accomplish expansion of the patient's palate.

For example, described herein are palatal expanders having an expansion region that is not centered in the palatal region but is offset. The expansion region is a plane and/or line, extending generally in an anterior to posterior direction (e.g., in a sagittal direction) through the head; expansion of the palate may occur relative to this plane and/or a line within this plane (the expansion axis). In some cases the left and right sides of the maxillary jaw may move (‘expand’) relative to the expansion axis, either or both in translation and/or in rotation. In the context of an orthodontic device such as a palatal expander, the expansion plane or expansion axis may be apparent based on the symmetry of the force(s) applied by the orthodontic device to the oral cavity when the device is worn. In cases where the patient has an expansion plane or expansion axis that is offset from the midline as described herein (e.g., the mid-sagittal plane), this asymmetry may be generally apparent as an asymmetry of the palatal region of the device. Further, an offset of the expansion plane or expansion axis may be readily apparent when comparing the palatal expanders across a series of palatal expanders.

For example, a series of palatal expanders having a sequence and configured to be sequentially worn by a patient to expand the patient's palate the series of palatal expanders may include, for each palatal expander in the series: a left tooth engagement region, a right tooth engagement region, and a palatal region between the left tooth engagement region and the right tooth engagement region, wherein, for one or more palatal expanders in the series of palatal expanders, the left maxillary portion and the right maxillary portion are separated relative to each other relative to an expansion plane that is offset relative to a midline of the palatal region.

For each palatal expander, the top surface of the palatal expander may be offset from the bottom surface by a thickness such that an average thickness of the palatal region varies between different palatal expanders of the series. The tilt angle between the left tooth engagement region and the right tooth engagement region may increase relative to subsequent palatal expanders in the sequence, so that palatal expanders configured to be worn earlier in the sequence have a lower tilt angle than palatal expanders configured to be worn later in the sequence, further wherein the tilt angle is an angle relative to a plane through a midpoint of the teeth of the patient's upper jaw in an initial position of the patient's teeth in the upper jaw when the first palatal expander is worn by the patient. Any of the palatal expanders in the series may include a top surface that is configured to face the patient's tongue when the palatal expander is worn that is smoother than a bottom surface that is configured to face the patient's palate when worn. The left tooth engagement region of the palatal expander may include a left buccal extension region configured to extend at least partially over the patient's gingiva when the palatal expander is worn by the patient; alternatively or additionally, the right tooth engagement region of the palatal expander may include a right buccal extension region configured to extend at least partially over the patient's gingiva when the palatal expander is worn by the patient. Each palatal expander in the series may include a visible identification marking on a flat posterior surface, wherein the identification marking encodes one or more of: a patient number, a revision indicator, an indicator that the apparatus is a palatal expander or a retainer, and an indicator of where in the sequence the palatal expander is to be worn by the patient.

As mentioned above, the series of palatal expanders described herein may include a thickness of the palatal region that is different between members of the series. For example, the palatal expanders may be configured so that the thickness of the same region(s) of the palatal expander may vary between the different palatal expanders in the sequence or series of palatal expanders in order to achieve the movement determined by the modeling as described herein. For example, a series of palatal expanders may be configured to be worn in a defined sequence to expand the patient's palate, in which, for each palatal expander in the series: a left tooth engagement region, a right tooth engagement region, and a palatal region between the left tooth engagement region and the right tooth engagement region, wherein, for each successive palatal expander in the series of palatal expanders after a first palatal expander in the sequence, the left maxillary portion and the right maxillary portion are progressively separated relative to each other, and a thickness of the palatal region is different than a thickness of the palatal region from the prior palatal expander in the sequence.

All of the methods and apparatuses described herein, in any combination, are herein contemplated and can be used to achieve the benefits as described herein.

### BRIEF DESCRIPTION OF THE DRAWINGS

A better understanding of the features and advantages of the methods and apparatuses described herein will be obtained by reference to the following detailed description that sets forth illustrative embodiments, and the accompanying drawings of which:

FIG. 1 illustrates one example of a palatal expander including an enclosed attachment that may aid in retention within the oral cavity.

FIG. 2 is an example of a palatal expander having open attachments for retention and application of force.

FIG. 3A illustrates one example of a method of forming a series of customized palatal expanders as described herein.

FIGS. 3B and 3C illustrate translation and rotation of a typical dental arch during treatment to expand the palate. FIG. 3B shows the non-uniform expansion of the mid-palatal suture in which the anterior region separates more than the posterior region. FIG. 3C is a front view of the maxilla shown in FIG. 3B, illustrating rotation of the right and left maxillary halves.

FIGS. 3D and 3E illustrate tipping (e.g., rotation of teeth crowns in the buccal-lingual direction) during palatal expansion. FIG. 3D shows the teeth before palatal expansion and FIG. 3E shows the same teeth after palatal expansion.

FIG. 3F illustrates an example of reference axes (the transverse axis, sagittal axis and vertical axis) for an upper jaw.

FIGS. 4A-4D illustrate movement of portions of a digital model of the patient's oral cavity (e.g., palate and/or teeth) about an expansion axis.

FIGS. 5A and 5B show another view of a simulated expansion model of the upper palate; FIG. 5A is not expanded and FIG. 5B show the palate expanded by rotation about an expansion axis.

FIG. 6A illustrates an exemplary method of determining an expansion axis.

FIG. 6B schematically illustrates an example of an upper arch having an offset suture.

FIG. 7 schematically illustrates one example of a method of forming one or more dental appliances (e.g., palatal expanders) as described herein.

FIGS. 8A-8D show an example of a cone-beam computed tomography (CBCT) image from which material properties may be determined.

FIGS. 9A-9C illustrate one example of a digital model of a skull and a traditional palatal expander (shown in FIG. 9C).

FIGS. 10A-10C illustrate one example of a finite element analysis of a patient (the example shown in FIGS. 9A-9C) illustrating the stress distribution in frontal (FIG. 10A), horizontal (FIG. 9B) and mid-palatal suture (FIG. 9C) views.

### DETAILED DESCRIPTION

The methods and apparatuses (e.g., devices and systems, including software, hardware and/or firmware) described herein may be configured to generate one or more dental appliances, such as palatal expander, retainers, etc. to expand a patient's palate using internal topological features (or internal topological information about these one or more features) and/or material properties of the one or more regions of the patient's maxillary jaw, including but not limited to, the palatal region. The methods and apparatuses described herein may use cone beam tomography (CBCT) scan data of the patient's jaw and may determine relevant material properties and/or internal topological information. In particular, these methods and apparatuses may determine material properties, such as stiffness (e.g., Young's modulus), for one or more regions (including for a plurality of sub-regions) of the patient's maxillary jaw. The methods and apparatuses may alternatively or additionally determine internal topographic information such as the location, geometry, and/or orientation of the median palatal suture (“suture”) of the upper jaw. The material properties (e.g., Young's modulus, density, etc.) and/or internal topographic information (e.g., suture) may be used to generate a treatment plan including one or a plurality of palatal expanders. Also described herein are one or more palatal expanders, including a sequence of palatal expanders, that may include distinct features that benefit from the use of the CBCT scan data, such as matching the location of a plane or axis of expansion to the suture position and/or varying the thicknesses or material properties of the palatal expander to control rotation (e.g., tipping). Although the disclosure focuses on using CBCT to determine internal topological information (e.g., suture and bone features, cartilage features, material properties) of a patient's intraoral cavity (e.g., palate), any other technique for determining such internal topological information may be used mutatis mutandis (e.g., X-Ray, near infrared imaging) in the methods and systems disclosed herein. For example, X-Ray data may be used to determine information about the suture (e.g., location, orientation, and/or geometry of the suture), material properties such as stiffness of the bone and/or cartilage along one or more regions of the palate, etc.

The methods and apparatuses described herein solve technical problems associated with designing and making palatal expanders by providing a technical solution including the extracting one or more material properties of the patient's dental arch from CBCT data. For example, the methods and apparatuses described herein may extract material properties of the dental arch from CBCT scan data of the arch, and may apply these material properties to generate more accurate modeling and therefore improved patient treatment. More accurately modeling internal structures using the material properties, such as the Young's modulus of the tissue and the accurate location of the palatal suture, results in more accurate predictions and staging of tooth treatment planning, improved patient treatment, may reduce the need for course correction, may reduce the risk of serious complications like fenestration and dehiscence and may help achieve an ideal arch form. These technical solutions may also reduce the processing time needed to generate the treatment plans, and may therefore result in faster results and more efficient use of limited computing resources. The methods and systems described herein integrate the use of CBCT scan data into palatal expansion treatment by extracting one or more material properties of the patient's dental arch from the CBCT scan and incorporating those material properties into the patient treatment as a practical application of these techniques.

In general, the apparatuses and method described herein are configured to progressively expand the palate of a patient and may include palatal expanders that are fabricated based on a model, including in particular a digital model, of a patient's mouth, including the patient's dentition (e.g., teeth), gingiva, and/or palate. Thus, these methods and apparatuses for progressive palatal expansion may include a series of incremental expanders including a first incremental expander having a geometry selected to expand the palate, one or more intermediate expanders having geometries selected to progressively expand the palate to a target desired breadth. A final expander may be used to retain the palatal expansion in the patient over a post-treatment period, and/or may be used to begin or prepare the patient for further dental alignment, including alignment of the patient's teeth. In particular, described herein are methods and apparatuses for forming a series of palatal expanders that are customized to a patient's oral cavity.

Any of the methods or apparatuses for forming a series of palatal expanders described herein may personalize the series of palatal expanders by modeling both the movement of the palate (and accurately estimating the new surface of the palate as it expands) and optionally in some variations, the movement of teeth within the patient's jaw, and use this modeling to design the series of palatal expanders.

Palatal expanders may be pre-formed devices having a first molar-engaging region adapted to engage one or more upper molars on a first side of the upper jaw, a second molar-engaging region adapted to engage one or more upper molars on a second side of the upper jaw and a palatal region configured to sit adjacent to (and in some configurations against) the palate while providing pressure to incrementally expand the palate. Each of the expanders in a series of expanders may comprise two molar regions, one on each side, each with one or more cavities, each cavity being adapted to fit over one of the patient's molars. In an especially preferred embodiment each molar region comprises two cavities, such that each molar region fits over two posterior molars or premolars. In other embodiments, each molar region may include any suitable number of cavities to fit over any suitable number of teeth. Each expander may further comprise a palatal region, which separates the two molar regions and fits over the patient's palate. In some embodiments, the palatal region is configured to engage the entirety of the patient's palate or at least a portion of the patient's palate. In other embodiments, the palatal region is shaped to include a gap between the palatal region and the patient's palate, as discussed below, so as to reduce the likelihood of irritation, infection, or tissue damage. The gap may be configured such that the palatal region does not engage any portion of the palate to prevent contact between the palatal region and the palate, or may be configured such that the palatal region does not engage the majority of the palate to reduce the contact between the palatal region and the palate. Typically, the distance between the molar regions in the series of expanders is sequentially greater.

The palatal region of any of these devices may provide force to expand the palate of the patient. In some embodiments, energy-enhancing features may be placed in this region (e.g., springs and thermally active materials), and/or this region may include one or more adaptations, such as struts, supports, cross-beams, ribs, gaps/windows, attachments, and the like which may distribute the forces applied in a more nuanced manner than previously described. For example, these devices may be configured so that the forces applied are distributed in a predetermined and/or desired pattern by arranging one or more points of contact between the palatal expander and the patient's mouth (e.g., in the gingiva and/or preferably along an upper or lower lateral portion of the patient's teeth, including their molars). The curvature (e.g., concavity) of the device may also be adjusted, to distribute the forces applied, while allowing clearance between the palate and the device, and/or allowing clearance for the user's tongue.

A series of palatal expanders as described herein may be configured to expand the patient's palate by a predetermined distance (e.g., the distance between the molar regions of one expander may differ from the distance between the molar regions of the prior expander by not more than 2 mm, by between 0.1 and 2 mm, by between 0.25 and 1 mm, etc.) and/or by a predetermined force (e.g., limiting the force applied to less than 100 Newtons (N), to between 8-100 N, between 8-90 N, between 8-80 N, between 8-70 N, between 8-60 N, between 8-50 N, between 8-40 N, between 8-30 N, between 30-60 N, between 30-70 N, between 40-60 N, between 40-70 N, between 60-200 N, between 70-180 N, between 70-160 N, etc., including any range there between). These devices and apparatuses may be configured to limit the movement and/or forces applied to within these ranges.

In any of the dental appliances, e.g., palatal expanders, described herein (and methods of fabricating them), the dental appliance may be formed out of a polymer and/or a metal material, including stainless steel, nickel titanium, copper nickel titanium, etc. In some examples the dental appliances described herein are laminated apparatuses, in which the apparatuses are formed for layers of material that may be formed and/or adhered together (e.g., to form a unitary device); different layers may have different mechanical and/or chemical properties, and may include different thicknesses or regions of thickness. For example, an apparatus may include laminated materials that are bonded together.

The apparatuses and methods of forming them may include fabricating one or more of the dental appliances by direct fabrication techniques. For example, an apparatus (including a series of palatal expanders) may be described as a digital model and fabricated by a direct printing technique (e.g., 3D printing); alternatively or additionally the fabrication method may include 3D printing one or more models of the teeth, gingiva, and palate that have been digitally configured and then forming (e.g., thermoforming) one or more of the appliances over the printed models.

Also described herein are methods of expanding the palate of a patient using any of the apparatuses described herein, which may include positioning each dental appliance (e.g., palatal expander) from a series of expanders in the patient's mouth to expand the palate, leaving the expander in position for a period of time and replacing the expander with the next expander in the series until the desired palatal expansion has occurred and then applying a palatal expander that is configured to retain the palate in the final position at the target desired breadth. Any of the methods of forming a series of palatal expanders describe herein may generally include: dividing a digital model of a patient's upper jaw into a left maxillary side and a right maxillary side; forming a plurality palatal expansion models of patient's upper jaw, wherein for each palatal expansion model, the left maxillary portion and the right maxillary portion are progressively translated relative to their original position; and generating a series of palatal expanders, wherein each palatal expander in the series corresponds to one of the palatal expansion models, further wherein each palatal expander comprises a tooth engagement region configured to be removably worn over the patient's teeth, and a palatal region.

Any of the methods described herein may include forming one or more models of a patient's maxillary region by dividing a digital model of a patient's upper jaw into a left maxillary side and a right maxillary side; forming a plurality palatal expansion models of patient's upper jaw from the digital model, wherein for each palatal expansion model, the left maxillary portion and the right maxillary portion are progressively translated relative to their original position in the digital model about a plane or axis of expansion that based at least in part of the patient's suture. Forming the plurality of palatal expansion models may include using the model in which material properties are included in the model. Examples of material properties that may be extracted from the CBCT scan and incorporated in the model may include tissue stiffness (Young's modulus) for sub-regions of the maxillary region including the bone, periodontal ligament, etc., and in particular different sub-regions of the palate (e.g., suture). The model may also include an accurate representation (location and/or orientation) of the suture. The digital model may be morphed to reflect an orthopedic expansion from the patient's suture (e.g., relative to the plane and/or axis of expansion). This modeling process may include determining the forces and/or locations of application of the forces, as part of a dental appliance such as a palatal expander, to accomplish the force resulting in the appropriate expansion and repositioning of the maxillary region. Thus, the method may generate a series of palatal expanders, wherein each palatal expander in the series corresponds to one of the palatal expansion models, further wherein each palatal expander comprises a tooth engagement region configured to be removably worn over the patient's teeth, and a palatal region.

In any of these methods and apparatuses (generally including apparatuses configured to perform any of these methods), a plane or axis for expansion, corresponding to a plane or axis for rotation/tipping of the left and right side of the upper jaw, may be determined. These methods and apparatuses may further determine the thickness profile across all or a portion of the apparatus, including across the palatal region, to accomplish the modeled movement (translation, tipping/rotation, etc.). Thus, the model may include material properties and internal topological information as part of a finite element analysis to determine the rate of expansion and/or the forces to apply to the patient's upper jaw (maxillary region) in order to achieve expansion in a manner that minimizes defects such as excessive unwanted tooth movement (including tipping), excessive local stain, excessive local stress concentration in bone, root collisions, fenestrations, dehiscence, protrusions of teeth roots from alveolar bone, etc. These methods may also be used to determine target dimensions, including in particular the thicknesses of the palatal region(s) or the palatal expanders.

In general, the methods described herein may apply sufficient force to breach or crack the suture while minimizing discomfort and defects. The methods and apparatuses described herein may take into account features that were previously believed to be too difficult to determine and account for, such as the incremental stiffness of the palatal region and the actual shape and orientation of the patient's suture. The use of these additional material properties (stiffness, bone density, etc.) and internal topological features (e.g., bone root morphology, bone morphology, suture topology, etc.) may result in determining the right force(s) a much more customized dental appliance.

The methods and apparatuses described herein may derive material properties of the sub-regions of the upper jaw from a CBCT scan. For example, the alveolar bone and/or palatal region (including the suture) may be described by one or more patient CBCT scans as grayscale contrast. Individual Young's modulus values for a region or volume of the upper jaw may be derived from the CBCT scan by calibrating a relationship between the tissue density and the gray scale using calibration phantoms. Calibration phantoms may be used to genrate a relationshp between bone density and/or other material properties, such as Young's modulus. For example, a calibration phantom may be a physical article made from one or more model materials (such as bone material, e.g., hydroxyapatite) at different, known densities. A CBCT scan of the calibration phantom results in a grayscale image in which the values of the grayscale may be correlated to the known bone densities. Thus, a grayscale value of a CBCT scan can be directly converted to a corresponding bone density value using a calibration curve taken from the same or a similar CBCT scan of the calibration phantom having known material properties. For example a first relationship between bone density and grayscale values of the calibration phantoms (with known densities) may be determined. A second relationship may be generated for bone density vs. material properties (such as Young's modulus) using bench-top testing and/or literature data. By combining these two relationships, a relationship between material properties versus the CBCT grayscale can be developed. Alternatively, CBCT gray value may be converted to material properties using CT attenuation coefficients (μ) of standard materials (e.g., control material values, such as aluminum, outer bone, inner bone, polymethylmethacrylate (PMMA), muscle, water, adipose, air, etc.). The corrected values of the scanned materials may be derived by estimating the attenuation values from the CBCT gray values. This may be comparable between different CBCT scanners.

Thus, the grayscale information from the CBCT scan may be used along with a segmentation of the CBCT scan to determine regions within the mouth (teeth, tooth roots, gingiva, alveolar bone, palatal region, suture, etc.). The CBCT scan may be segmented by automatic segmentation. In some examples a trained machine learning agent (trained on manually or checked segmented scans) may be used to segment all or a portion of a CBCT scan (including identifying one or more of: the tooth crowns, tooth roots, gingiva, alveolar bone, palatal region, suture, etc.). Segmented regions may be identified and corresponding values, including material property values, may be used as part of the modeling process.

Thus, in general the use of one or more CBCT scans may help determine an optimal force or force system to achieve palatal expansion while avoiding defects. This may allow fully customized palatal expanders. In general, the methods described herein may use and access a large database of CBCT scan data. The database may include patient-specific CBCT scans, taken before treatment (either immediately or virtually any time before start of treatment). The database may also include data from other patients. The database may be used for training one or more machine learning agents, as described herein.

In any of these methods and apparatuses the patient CBCT scan may be modified prior to being analyzed to determine the material properties and/or internal topological information. For example, the one or more patient CBCT scans may be calibrated to allow the use of grayscale to determine density and/or stiffness (e.g., Young's modulus). The calibration of the CBCT scan may be standardized.

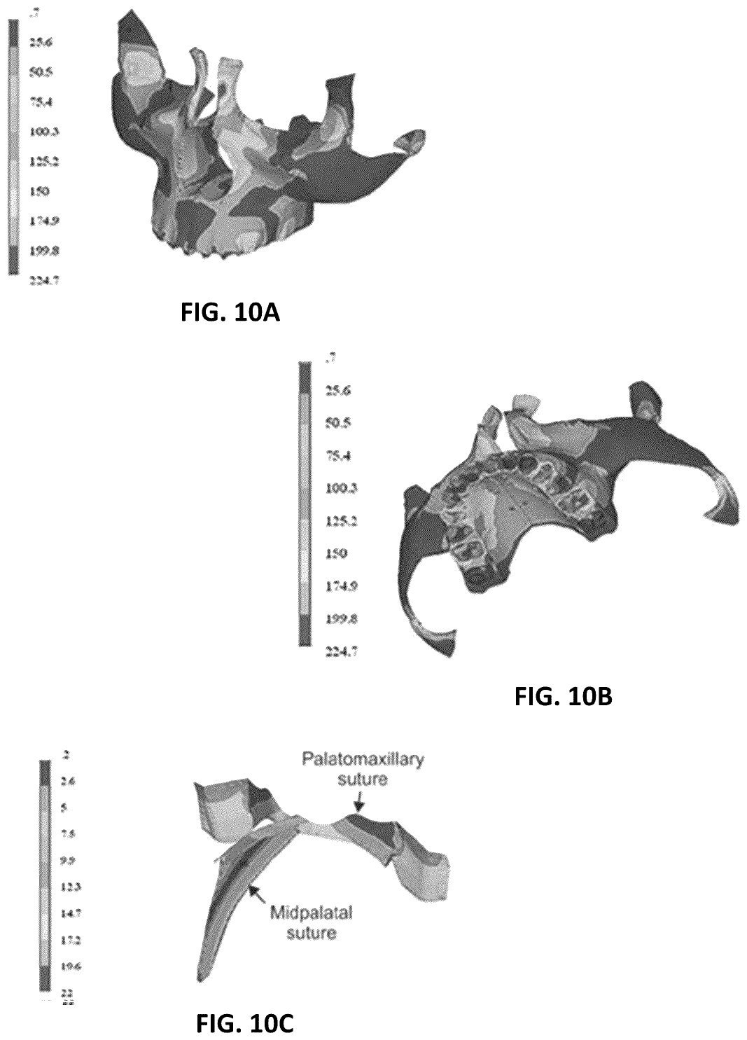

The local/regional stiffness, e.g., Young's modulus, may be used to modify a treatment plan and/or aligner. In some examples the estimated material properties may be used in a simulation (e.g., force model) of the forces acting on the patient's dental arch. For example, a finite element analysis (FEA) may be performed on a model of the patient's dentition including the local/regional Young's modulus determined from CBCT scan data as described herein; this analysis may determine regions of stress concentration (see, e.g., FIG. 10A, showing a heatmap of stress concentration). If the results of this modeling show an excessive amount of local stress concentration, the treatment plan can be modified to maintain a stress concentration level that is below certain limit (stress threshold). Specifically, the analysis may be used to change staging parameters for the treatment plan, such as: an amount of tooth tipping, the amount of horizontal expansion amount on separate teeth (including varying the amount of horizontal expansion on some or all of the teeth), the speed of expansion, etc. Optionally, this process may be iterated, e.g., adjusting one or more parameters until the simulation determines that the stress concentration is below the desired (preset or user defined) stress threshold. In addition to the absolute limit (stress threshold), this technique may consider and account for the location or distribution of the stress. For example, the method may be used to avoid applying stress to certain regions of the dental arch (e.g., some teeth, palatal region, gingiva, etc.).

In general, the palatal expansion apparatuses described herein are worn as a series of expanders by a patient. These palatal expanders may be configured to apply force within the patient's mouth to expand the patient's maxilla. In particular, described herein are apparatuses, e.g., devices and/or systems, including individual palatal expanders and/or a series or sequence of palatal expanders, and methods of making and using such apparatuses. The methods and apparatuses described herein include methods and apparatuses (e.g., systems, including software, hardware and/or firmware) for planning and generating a sequence of palatal expanders that may more comfortably and/or efficiently move the patient's left and right maxillary halves. These methods may limit the force and/or rate of movement delivered by each palatal expander in a sequence of expanders. Any of these methods and apparatuses may also account for translation and rotation of the left and/or right maxillary halves as treatment progresses, and may also optionally account for tipping of the teeth (e.g., rotation in the buccal-lingual direction), and changes in the shape (morphology) of the palate as treatment progresses.

These apparatuses may be configured to apply between 8-120 N of force to expand the patient's palate. These apparatuses may be considered ‘slow’ expansion apparatuses (e.g., applying around 8-10 N of force between the molars on either side of the upper jaw of the mouth), or ‘rapid’ expansion apparatuses (e.g., applying greater than 20 N for higher speed expansion, e.g., between 20 and 40 N, between 20 and 60 N, between 70 and 160 N). In some variations, the apparatuses may be configured to drive displacement and/or force to cause an expansion of the palate. For example, any of these apparatuses may be configured to expand the palate by moving the left and right maxilla at a velocity of about 0.25 mm/day (e.g., when worn for a 24-hour wear time). These apparatuses (e.g., devices) may form a series of devices that may be used to displace the palate, expanding it and causing transverse force between the molars on either side of the mouth.

In general, the apparatuses described herein may include a gap between the upper surface of the mouth (the palatal surface) and the palatal expander. This gap may be, for example, between 0.1 mm and 10 mm (e.g., between 0.2 mm and 9 mm, between 0.3 mm and 9 mm, between 0.5 mm and 8 mm, between 1 mm and 7 mm, between 2 mm and 5 mm, etc., including any region or sub-regions there between). This gap may prevent soft tissue irritation. The gap may extend over 50% of the portion of the apparatuses that are positioned opposite of the patient's palate, when worn by the patient (e.g., over 60%, over 70%, over 80%, over 90%, over 95%, etc.). The gap may be centered in the mid-palatal region (e.g., along the mid-palatine suture, etc.). In some examples the gap may be centered over the expansion axis, which may be offset from the mid-palatal region (e.g., the gap may be positioned to the left or the right of the mid-palatal region or line; the gap may be skewed, angled, or otherwise shaped to conform to the expansion axis) and/or may change during the treatment, as described herein. In some variations, the shape of the palatal portion of the expander (e.g., the portion facing the patient's palate when worn by the subject) may be contoured to match the contour of the patient's palate (either with or without an offset, as just described) and may include ridges, channels, etc. In contrast, the opposite surface of the palatal region (e.g., the lingual, tongue-facing side) may be smoothed and may have a very different.

As will be described in greater detail below, the shape of the apparatus (e.g., the palatal expander), and therefore the load (e.g., force or forces) applied by the apparatus when worn, may be controlled and selected as part of the method of forming described herein. It may be particularly advantageous to provide a digital planning process in which a digital model of the patient's upper jaw (e.g., teeth, palate, and gingiva), and in some cases the subject's lower jaw (e.g., teeth and/or gingiva) may be modified to plan the series of expanders that morph between the patient's initial anatomy to an expanded configuration in which the final expanded configuration is described. Designing an accurate and effective series of palatal expanders should ideally accurately model the palatal expansion to include both linear translation (e.g., in an xy-plane) and rotational translation of the right and left maxillary halves, and optionally include translation of one or more of the teeth, and optionally include tipping of the teeth due to the forces applied by the palatal expander. Optionally, the design of a series of palatal expanders may also include an effect on the lower jaw, and in particular the interaction between the lower and upper jaw (e.g., intercuspation). Superior results may be achieved by accurate digital modeling of the teeth, gingiva, and palate of the upper jaw (and in some variations the teeth of the lower jaw), and by controlling the planned movement (e.g., expansion of the palate, which may be expressed as the separation between the molars) and the forces acting on one or more of the teeth, palate, and/or gingiva. In addition, the palatal expanders may also be digitally modeled, including modeling both the shape (dimensions, including thickness, curvature, attachment points, etc.) and the material(s) used. Thus, the expander(s) in a series of expanders may be accurately and in some cases automatically, configured so that they achieve the desired palatal expansion within predetermined (or user/physician/technician) adjustable parameter ranges such applied expansion force (e.g., between x and y Newtons, less than y Newtons, etc., where x is about 5, 6, 7, 8, 9, 10, 15, 20, 25, 30, 35, 40, 45, 50, 60, 70, etc. and y is about 10, 20, 30, 40, 50, 60, 70, 80, 90, 100, 110, 120, etc., and y is less than x), the location of applied forces in the patient's mouth (e.g., upper lateral portion of the molars, mid-lateral portion of the molar, lower lateral portion of the molars, gingiva, palate, etc.) and/or portions of the patient's mouth to avoid contact (e.g., gingiva, palate, mid-palate, lateral palate, etc.). These methods and apparatus may be constrained to prevent or limit force and/or movement applied to reduce or prevent defects such as root collisions, fenestrations, dehiscence, protrusions of teeth roots from alveolar bone, etc.

As will be described in greater detail below, the shape of the apparatus (e.g., the expander), and therefore the load (e.g., force) applied by the apparatus when worn, may be controlled and selected during the fabrication process. It may be particularly advantageous to provide a digital planning process in which a digital model of the patient's upper jaw (e.g., teeth, palate, and gingiva), and in some cases the subject's lower jaw (e.g., teeth and/or gingiva) may be modified to plan the series of expanders that morph between the patient's initial anatomy to an expanded configuration in which the final expanded configuration is described. Designing an accurate and effective series of palatal expanders may include modeling the palatal expansion to include both linear translation (e.g., in an xy-plane) and rotation of the right and left maxillary halves, and optionally may include translation of one or more of the teeth, including rotation of the teeth due to the forces applied by the palatal expander. The models described herein may take into account one or both of: the actual position and/or orientation of the patient's suture and/or the incremental stiffness across the upper jaw, and in particular the palatal region.

### Expander FeaturES

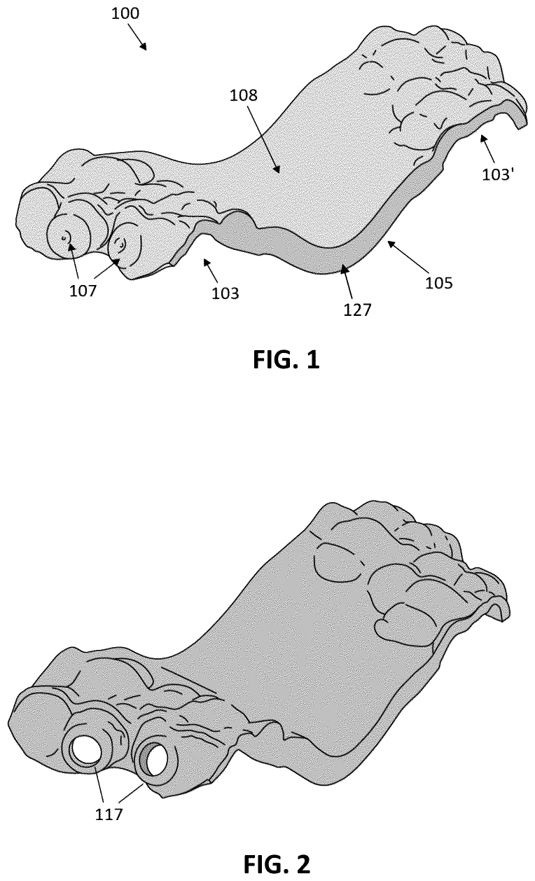

The palatal expanders described herein may include one or more tooth engagement regions for engaging at least a subset of the teeth in the patient's upper jaw, in particular the molars, and a palatal region extending between the one or more tooth engaging regions (e.g., between two contralateral tooth engagement regions) that is configured to be positioned adjacent and opposite from the patient's palate when the device is worn by the patient. For example, FIG. 1 shows an example of a palatal expander 100 that includes a pair of tooth engagement regions 103, 103′ on either side of the device, connected by a palatal region 105. In this example, the palatal expander also includes a pair of attachment regions 107 that may each receive an attachment that is bonded to the patient's teeth, e.g., on either side of the device (on a buccal side of the patient's teeth). The attachment may be secured to the teeth in a position that allows it to couple (e.g., removably couple) to the attachment region(s) on the expander. An attachment may be bonded (glued, etc.) to the teeth as part of an initial step prior to wearing the series of expanders. In the apparatus shown in FIG. 1, the palatal region has a convex upper surface 127 that is opposite the concave lower surface 108. The lower surface is a lingual (tongue-facing) surface; the upper surface faces the palate.

The tooth engagement regions may be formed of the same material(s) as the palatal region, or they may include different materials. The thickness of the tooth engagement regions and the palatal regions may be different or the same. In particular, the palatal region may be thicker than the tooth engagement region. The thickness of the tooth engagement region may be thicker along the lateral (e.g., buccal and/or lingual) sides of the device and thinner (or removed from) across all or a portion of the top of the tooth engagement region. The palatal region may have a non-uniform thickness. For example, the palatal expander may be thicker near the midline of the device. Any of the palatal expanders may include ribs or other supports (e.g., extending transversely between the tooth engagement regions and/or perpendicular to the tooth engagement regions). These ribs may be formed of the same material as the rest of the palatal region (e.g., but be thicker and/or shaped to have a cylindrical cross-sectional profile).

The inner (cavity) portion of the tooth engagement region is typically configured to conform to the outer contour of the patient's teeth, and to rest directly against the teeth and/or a portion of the gingiva (or to avoid the gingiva) to apply force thereto. The upper surface of the palatal region which is positioned adjacent to the palate when worn by the patient may be contoured to match the actual or predicted shape of the patient's palate. As mentioned above, all or a significant portion of the palatal region may be separated or spaced from the patient's palate when worn, which may enhance comfort and minimize disruption of speech.

In some variations, a portion of the palatal region extending between the opposite tooth engagement regions on either side of the device (e.g., a portion of the palatal region extending approximately z % of the distance between the tooth engagement regions, where z is greater than about 30%, 40%, 50%, 60%, 70%, 80%, 90%, etc.) may be flat or straight, rather than curved, so that it does not necessarily follow the contour of the patient's mouth. This portion may be one or more transverse ribs, struts or supports, or it may be the flat sheet. Such a flat or straight portion may provide increased force. Alternatively or additionally, the palatal region (e.g., one or more ribs, the sheet, etc.) may be curved in an arc similar to the arc of the patient's palate, but may have a much larger radius of curvature (appearing as a shallower concavity) than the patient's palate.

Any of the palatal expanders described herein may include one or more attachment regions or sites (also referred to herein as attachment opening, attachment couplers, etc.) for coupling to an attachment on the patient's teeth. An attachment may be bonded to the patient's tooth and may include a projection, hook, etc. to engage with the attachment region. In particular, it may be helpful to use one or more (e.g., a pair) of attachment regions (e.g., attachment regions 107 in FIG. 1) on each side of the device. Furthermore, the attachment regions may preferably be openings through the expander. An open structure (attachment region) on the orthodontic expander may interact with attachments located on teeth to improve the overall retention of the appliance and in some cases may be used to generate advantageous force features for teeth alignment, including limiting or preventing rolling of the teeth buccally as the palate is expanded. Such features may be helpful, in particular, when included as part of a directly fabricated (e.g., 3D printed) device for rapid (e.g., phase 1) palatal expansion. Attachments and attachment regions may be used as part of any expander. Further, although the attachment is typically bonded to one or more teeth and projects into a complimentary opening or cavity on the expander, this configuration may be revered in some or all of these; for example, the protruding attachment may be part of the expander which may insert into an opening/cavity bonded to the user's teeth.

Any appropriate attachment region may be used, and in particular any appropriate size and/or shape may be used. As mentioned, the attachment region may preferably be an open structure on the appliance which may improve retention of the appliance over the attachments and possibly include force features for teeth alignment. For example the attachment region may comprise a round, oval, square, rectangular, triangular, etc. opening through the expander (e.g., at a lateral, e.g., buccal, side of the tooth regaining region of the expander. The attachment region may be keyed relative to the attachment connector; in general the attachment may be configured to mate with the attachment region in one or a particular orientation.

An open attachment region may reduce non-compliance of the appliance to poorly cured attachments. The open structures may enable complete coverage over a pre-determined attachment shape and size. Any of these attachment region/attachment couplings may incorporate biomechanical force features with this appliance/attachment interaction, including, as described above, keyed regions that transmit rotational force in the plane of the opening (e.g., against the surface of the tooth), for example. In some variations the attachment may snap or couple into the attachment region in a manner that requires a force to disengage the coupling.

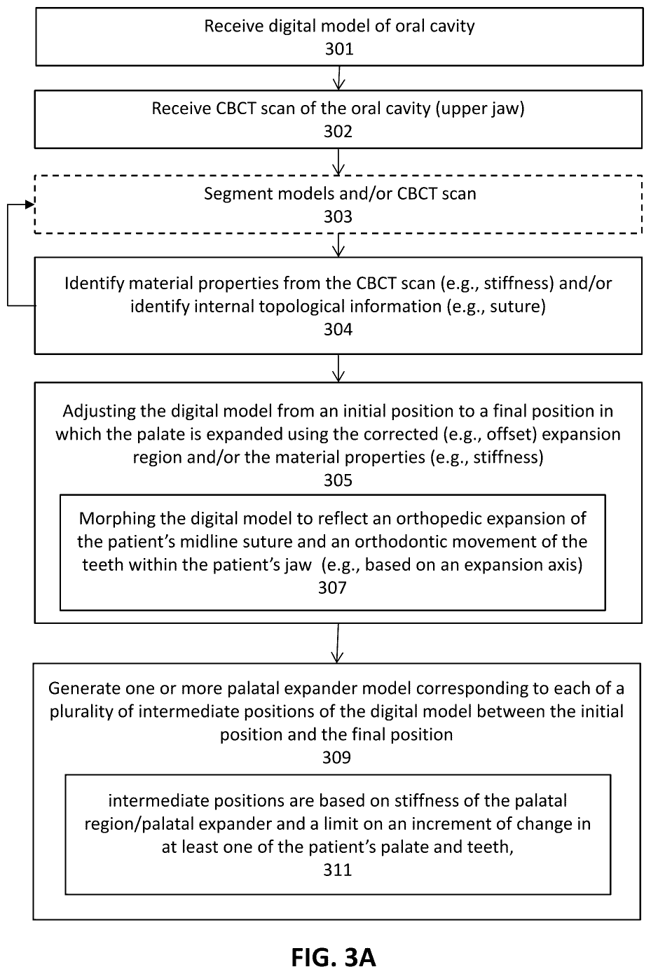

As shown in FIG. 1, an appliance design may enclose the attachment that helps maintain retention in the oral cavity. Alternatively, the variability in the size of these attachment regions due to appliance fabrication (e.g., thermoforming, direct fabrication, etc.) may be reduced by creating an open structure, as shown in FIG. 2. In FIG. 2, the palatal expander is otherwise quite similar to what is shown in FIG. 1, but includes two open attachment regions 117.

In some examples the dental appliance, e.g., palatal expander, may be configured so that an expansion plane is offset relative to a midline of the palatal region. For example, the palatal region may be configured so that the expansion force applied between the right and left sides (right and left maxillary regions) are distributed differently between the two sides. For example, the palatal region may include a strut or support that directs the force between the left and right sides differently between the left side and the rights side. In some cases, the support or strut may be a thickening region, or a region having different stiffness and may be bifurcated or divided (e.g., a Y-shape or other pronged shape); the vertex of the bifurcation may be offset to the left or to the right based on the location of the patient's suture.

### Palatal Expander Series

A series of palatal expanders may be customized by digitally modeling the patient's oral cavity and automatically, semi-automatically or manually manipulating the digital model to plan the series of palatal expanders to be worn to achieve a desired final configuration of the patient's upper arch at the end of the palatal expansion treatment. In some variations, the final position may be determined as an endpoint for the palatal expansion, and the stages of palatal expanders used to achieve this final configuration may be determined. The stages may be referred to as intermediate positions. A customized palatal expander may be generated for each intermediate position and for the final endpoint (including a maintenance device to be worn for a period of time, e.g., 1 month, 2 months, 3 months, 4 months, 5 months, 6 months, etc.) after expansion of the palate. The methods and apparatuses described herein may be configured to design each palatal expander, including the stiffness and/or shape of the palatal expander (and in particular the palatal region, referred to herein as the IPA or interpalatal arch) by modeling both the orthopedic movement of the arch and the orthodontic movement of teeth in the jaw bone, the material properties (e.g., stiffness) of the upper jaw, and the internal topography (e.g., suture), and applying constraints on the movements of the palate, teeth and/or gingiva in the jaw, including constraints (e.g., limits) on one or more of: the rate of movement of the two sides of the palate, the rate of expansion as measured between two or more subsets of teeth (e.g., between a first set of molars on a first side and a second set of molars on the contralateral side of the patient's upper jaw), an amount of force applied to the patient's oral cavity, a rate of dental movement of the patient's teeth, and a rate of change of an angle between a left and a right portion of the palate. Other constraints may prevent or limit the movement from generating or exacerbating a defect such as root collisions, fenestrations, dehiscence, protrusions of teeth roots from alveolar bone, etc. These constraints may be expressed as a limit on an increment of change of these movements. The patient's age may also be used to model or simulate movement of the palate and/or teeth.

In general, palatal expanders customized to a particular patient may be based on manipulation of a digital model of the patient's oral cavity that includes both orthopedic (e.g., bone movement from palatal expansion) and optionally orthodontic (e.g., tooth movement within the jaw) movements to create a series of palatal expanders.

For example, described herein are methods and apparatuses for designing and fabricating customized palatal expanders (e.g., rapid palatal expanders) based on a digital model. In general, any of these methods may include taking/receiving a digital model of patient's oral cavity, include the patient's palate surface. For example, a digital scanner may be used to scan the patient's oral cavity (e.g., teeth, gingiva, palate, etc.). Optionally, the digital model may be segmented into tooth, gingiva, and palate models. Segmenting may be helpful when separately modeling tooth movement within the jaw (orthodontic movement) and palatal movement (orthopedic movement). Alternatively, orthopedic and orthodontic movements may be modeled together (though even if modeled using separate components, the two may interact so that movement of the jaw may inform movement of the palate, and/or vice versa). The method and apparatus may determine a final position of the palate and/or teeth to be achieved by the series of expanders, including staging orthopedic and orthodontic movement to achieve the final position. This modeling may then be used to design a customized rapid palatal expander for a specific patient. Thus, in any of the methods and apparatuses described herein, the digital model may be used to predict both orthopedic (palatal) and orthodontic (dental) movement, and the model may be used to determine a final position setup and to define the movement/velocity of the palatal expansion and/or teeth.

As part of the modeling, a digital representation of the palatal surface (referred to herein as the digital palatal surface) being remodeled may be morphed for treatment simulation, prediction, and palatal expander design. Accurate morphing of the digital palate during modeling and simulation may allow the custom palatal expanders (and particularly the palatal regions) to be accurately designed, including providing appropriate or desired spacing from the patient's palate, or in some variations a snug fit against the patient's palate.

The palatal expanders described herein may be rapid palatal expanders. The method and apparatuses for designing these customized rapid palatal expanders may include controlling force and stiffness based on treatment stage, age, arch shape, and other information.

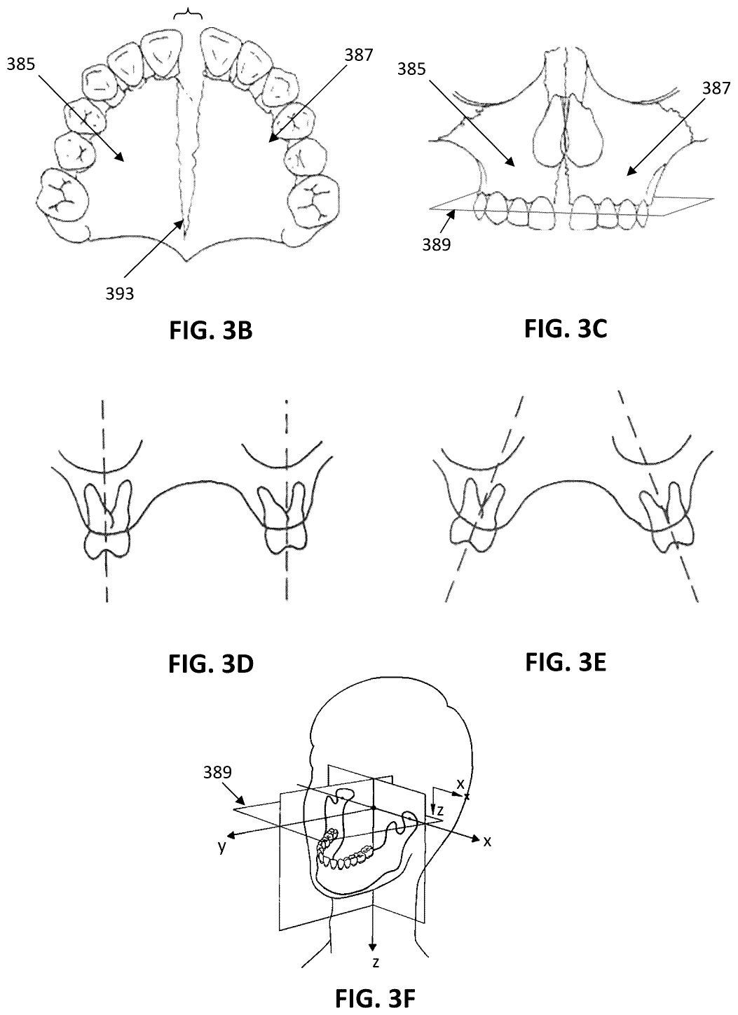

FIG. 3A illustrates an exemplary method of designing and/or forming one or a series of customized palatal expanders. In FIG. 3A, the method, or an apparatus (e.g., a device or system, including software, hardware and/or firmware) performing this method, receives a digital model of the patient's oral cavity 301, and a CBCT scan 302. This method and/or apparatus may be used to automatically or semi-automatically design one or more palatal expanders, e.g., a series of palatal expanders, which may be fabricated by any of the techniques described herein and worn by the patient. When configured to operate semi-automatically the apparatus may operate interactively with a user, such as a dental technician, physician, dentist, orthodontist, etc., so that the at least some of the design parameters and decisions may be guided by the user, who may be provided immediate feedback, including visual feedback and modeled feedback on the forces acting on the simulated expander and patient's dentation.

In general any of the methods and apparatuses configured to perform these methods described herein may be performed by a dedicated apparatus, which may include digital inputs (digital file inputs and user inputs, such as keyboards, etc.), one or more processors, at least one visual output (e.g., screen, printer, etc.) and one or more digital outputs, including a digital file output for use in fabrication, such as direct (e.g., 3D printing) fabrication. Alternatively or additionally, the method and an apparatus performing the method may be performed by a general-purpose device executing the specific and/or specifically adapted control logic. Thus, in any of these variations, the apparatus may be configured as control logic (e.g., software, firmware, etc.) that causes a processor (microprocessor, etc.) to perform the various functions recited. Any of the apparatuses described herein may comprise non-transitory computer-readable storage medium storing a set of instructions (control logic) capable of being executed by a processor, that when executed by the processor causes the processor to perform operations ultimately forming one or more customized expanders. The control logic may be specifically adapted to operate on a processor of a local or remote computer (laptop, desktop, etc.), remote server, smartphone, pad, wearable computer (smartwatch, etc.).

In FIG. 3A, the method or apparatus configured to perform this method receives the digital model of the patient's oral cavity 301 and the CBCT scan 302. This digital model may be provided by one or more sources, including in particular digital scanning systems, including intraoral scanners, such as those described in U.S. Pat. No. 7,724,378, US 2016/0064898, U.S. Pat. No. 8,948,482,US 2016/0051345, US 20160003610, U.S. Pat. No. 7,698,068, US 20160163115, U.S. Pat. No. 9,192,305 and US 2015/0320320, which may be used to determine topological representations of a subject's teeth and/or gingiva and/or palate. The patient's mouth may be directly or indirectly scanned (e.g., scanning a model or impression of the patient's mouth). Other scanning systems may include scanning trays or the like (see, e.g., U.S. Pat. No. 8,520,925). The digital model may be multiple digital models of different portions or regions, for example, separately including the teeth, gingiva, and palate, or separately including different regions of all three that may be combined into a single digital image of the entire oral cavity or relevant part thereof. In any of these apparatuses and methods, both the upper and lower jaws may be digitally scanned and provided. In particular, the teeth of the lower jaw may be included, as well as the teeth, gingiva, and palate of the upper jaw.

Optionally, the digital model of the oral cavity surface and/or the CBCT scan of the internal features may be segmented 303 into separate tooth/teeth, and/or gingiva and/or palate models that together form a digital representation of the patient's oral cavity, including the palatal surface. This digital representation can then be used to model the orthopedic movement of the palatal expansion and the orthodontic movement of the teeth. The user can provide the targeted final position and/or use or adjust the model to predict orthodontic movement of the teeth. The method may then include identifying 304 one or more of material properties and/or internal features (e.g., internal topological features), such as the suture, tooth roots, etc. These additional material properties and internal features may be combined with the surface scan of the digital model of the oral cavity.

The digital model may adjust from the initial position to a final position in which the palate is expanded using the corrected (e.g., offset) expansion region and/or the material properties (e.g., stiffness) 305. The digital model may be morphed to reflect an orthopedic expansion of the patient's midline suture and an orthodontic movement of the teeth within the patient's jaw 307. In general, when modeling the incremental palatal expansion to stage the palatal expansion, the movement of the palate (e.g., the outward expansion of the palate forcing apart the right side of the palate from the left side of the palate, on either side of the suture, which may be offset relative to the midline of the application) may be based or approximated from anatomical constraints. For example, the movement of the right and left sides of the palate, based on a plane of rotation (or an axis of rotation that extends within the plane of rotation) that may be determined as described herein may be rotationally moved relative to an expansion axis that extends in an axis away from the patient's face, at an angle (e.g., of between 5 degrees and 85 degrees, e.g., between 5 degrees and 50 degrees, between 10 degrees and 70 degrees, etc.) relative to an xy-plane through the midpoint of the teeth in the upper arch, e.g., in a mid-plane of the patient's face extending between the patient's nose and a back of the patient's upper jaw. Other methods guiding the movement of the palate and/or jaws and/or teeth may be applied instead of or in addition to rotation about an expansion axis.

In FIG. 3A, once the final position of the palatal expansion is determined automatically, manually, or semi-automatically, the sequence of palatal expanders needed to accomplish this final position may be generated using the digital model. Any number of steps or stages, each corresponding to a removable palatal expander that may be applied and/or removed by the patient (or the patient's caregiver, e.g., especially for young patients), may be determined. For example, the method or an apparatus configured to perform the method may generate a plurality of intermediate positions of the upper arch, and from this model a palatal expander model corresponding to each intermediate and the final position may be generated 309. For example, the method or apparatus may determine each stage (each intermediate position) based on a stiffness of the palatal expander and a limit on one or more of the rate of movement of the patient's teeth when the palatal expander corresponding to that stage is worn, and/or a limit on the force(s) applied by the palatal expander to the patient's oral cavity or regions of the oral cavity. The modeling (e.g., morphing) step may be configured to permit processing to prevent one or more defects (e.g., defects such as root collisions, fenestrations, dehiscence, excessive amounts of local strain and/or stress concentrations, protrusions of teeth roots from alveolar bone, etc.). For example the method or apparatus may determine intermediate positions based on an increment of change in at least one of the patient's palate and teeth, where the increment of change is one or more of: a rate of expansion between the molars, an amount of force applied to the patient's oral cavity, a rate of dental movement of the patient's teeth, and/or an angle between a left and a right portion of the palate 311. Once topology and/or material properties are identified, a finite element analysis may be performed to identify the strain/stress distributions within a model of the dental arch. If the local strain/stress concentration exceeds a threshold (e.g., is determined to be too high), staging patterns for the dental treatment plan may be modified. In some examples, the rotational axis may be determined based on the internal topography and predetermined staging patterns (for the treatment plan) may be applied based on the orientation of the determined rotational axis. In some examples a library of material properties may be used where material properties cannot be extracted from the CBCT images (such as, for example, the periodontal ligament), as described herein; this may be performed according to the orientation of the axis of rotation.

In any of these methods and apparatuses, the final and incremental positions may be modeled to include both the translational movement and rotation of the left and right maxillary halves. This is illustrated in FIG. 3B and 3C. In general, palatal expansion with the apparatuses and methods described herein does not uniformly separate the right 385 and left 387 palatal regions. For example, the anterior portions of the palate will expand more than the more posterior portions, resulting in a triangular separation of the mid-palatal suture, as shown in FIG. 3B. In addition, as will be described in greater detail below and shown in FIG. 3C, the right 385 and left 387 maxillary halves of the palate (and therefore the suture) will be rotated about an axis that extends away from the patient's face at an angle (e.g., of between 5 degrees and 85 degrees, e.g., between 5 degrees and 50 degrees, between 10 degrees and 70 degrees, etc.) relative to an xy plane 389 through the midpoint of the teeth in the upper arch, which may be referred to herein as a midsagittal plane through the teeth of the upper arch. Thus in modeling the intermediate and final position of the palate during the expansion described herein, these methods and apparatuses may model both the translational movement (e.g., in the midsagittal plane through the teeth of the upper arch) as well rotation about this axis. The methods and apparatuses described herein may model and account for the more anterior separation of the palate 391 (compared to more posterior regions 393) and rotation in an axis extending at an angle to the midsagittal plane of the upper teeth. In addition, any of these methods and apparatus may also account for “tipping” of the teeth, as shown in FIGS. 3D and 3E. Tipping of the teeth refers to rotation of teeth crowns in the buccal-lingual direction (either buccally or lingually). Movement of the palate by applying forces may result in tipping of the teeth, both due to tipping of the arch (e.g., FIG. 3C) during expansion (e.g., generally along the coronal plane), but also due to force applied by the palatal expanders on the teeth. In FIG. 3E the teeth are tipped buccally compared to the original position shown in FIG. 3D.

As mentioned above, in setting the final position and/or the intermediate positions (stages), the left and right maxillary halves may be moved so that the left and right maxillary halves (including teeth, gingiva, and palatal regions) are rotated about an expansion axis that projects out from patient's head anteriorly, at an angle to the midsagittal plane of the upper arch and/or the occlusal plane; both the midsagittal plane of the upper jaw and the occlusal plane are horizontal (xy) planes. The occlusal plane may be the crown center plane of all of the upper teeth, for example, with the y-axis extending down the midline of the paired crown centers. As used herein, and illustrated in FIG. 3F, the y axis is a sagittal axis, the x axis is a transverse axis, and the z axis is a vertical axis. Expansion of the palate (e.g., expansion between the left and right maxillary halves) may result in movement of the teeth in the x direction, in the transverse axis, typically away from the intersection of the vertical axis, transverse axis and the sagittal axis. This movement may be constrained by the methods and apparatuses described herein so that the movement is coordinated about the expansion axis, resulting in an angled (e.g., V-shaped) separation between the left and right maxillary halves, with rotation in opposite directions around the expansion axis.

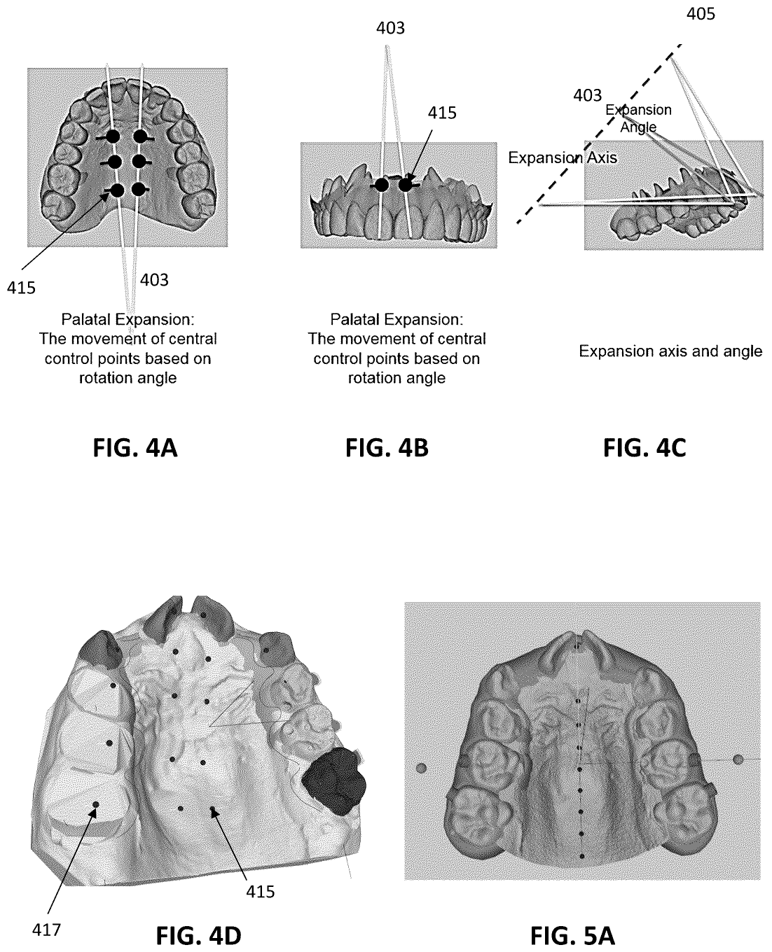

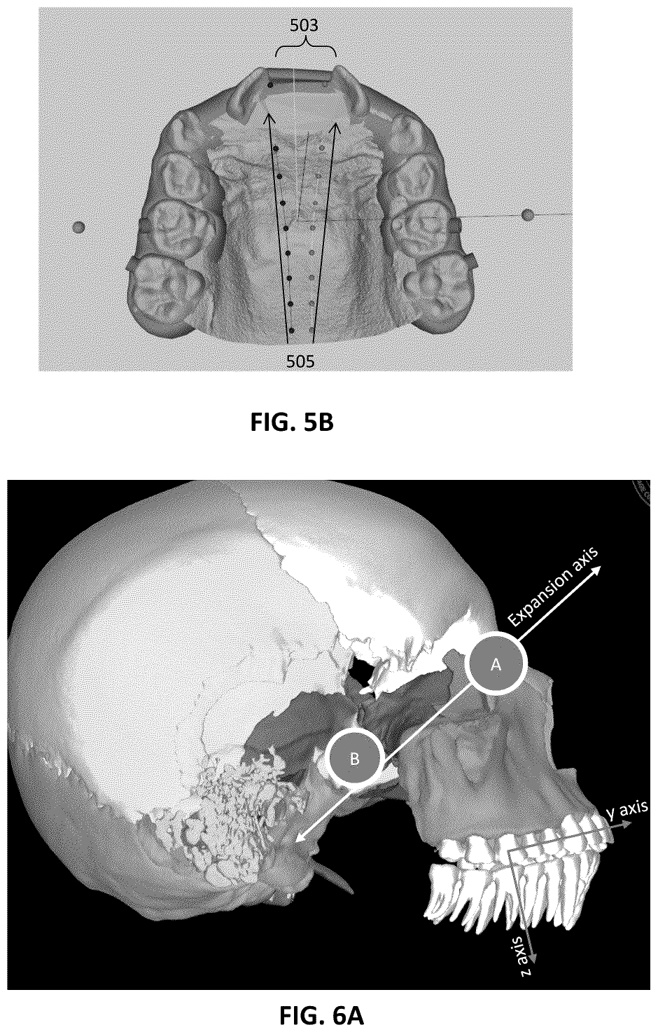

One example of such a constraint and method of modeling movement of the palate is the “expansion axis” mentioned above, and illustrated in FIGS. 4A-4D and 5A-5B. In any of these methods and apparatuses, the left and right maxillary jaw and palatal surface may be modeled as two moving parts. When determining the orthopedic and orthodontic movements of the patient's oral cavity from the digital model, each part can be rotated around one expansion axis, forming an expansion angle. The expansion angle may be the angle between the left and right maxillary halves (including the left and right palatal regions, respectively) about the suture (e.g., in a plane or axis of expansion). The expansion axis may be located in the plane of expansion, and may typically be located above the roof of the upper jaw, projecting anteriorly. As described herein the plane of expansion may be set by the suture, and may be offset from the midline of the upper jaw. For example, the expansion axis may be located offset from the middle plane of jaw/face, and roughly pass adjacent to a point near nose, and at the back of upper jaw.

FIGS. 4A-4C illustrate palatal expansion about an expansion axis, forming an expansion angle in a system in which the suture is symmetrically positioned between the left and right sides. FIG. 4A shows the separation of the left and right palatal regions when rotating about an expansion axis 405 (shown in FIG. 4C) forming an expansion angle 403. The movement of formerly central (along the midline suture) points based on the rotation angle is shown. FIG. 4A shows a view up to the upper jaw, while FIG. 4B shows a front view of the same digital representation of the jaw. FIG. 4C shows a perspective view with the expansion axis 405 labeled.

In modeling the final and intermediate positions for palatal expansion, the digital model of the patient's teeth that includes the palate (which may be referred to herein as a morphable palatal model) may be generated and manipulated. For example, the morphable palatal model may be formed by segmenting and removing the crown portion of the teeth (as shown in FIG. 4D). Some of the crown portions may be digitally removed from the model to simplify the morphing steps; the removed crown portions may later be added back. The teeth are rigid bodies that are not typically morphable. Lingual and buccal split curves from the gingival lines of the teeth may be formed. The initial palatal model may be created by mapping the three-dimensional vertex to a two-dimensional point. A mesh may be created by triangulation from the 2D projections taken from the 3D dataset, and mapped back to create a full 3D model that may be manipulated, including the palatal region and teeth. This 3D model may be morphed using any appropriate technique, including, e.g., Thin Plane Spline techniques. Morphing may be regulated by control points; for example control points may be placed on the teeth (crowns and/or centers) to control tooth movement and/or suture points to control the suture opening. Movement of these control points may be regulated by clinical constraints. For example, the direction and extent of movement may be limited or modified based on the relative location within the palate. FIGS. 4A, 4B, and 4D illustrate suture control points 415 and crown control points 417 that may be used when morphing the model. In some variations, morphing the model at the final and intermediate stages may include getting the control point(s) for each stage, morphing each vertex in the full palatal model (e.g., a digital model that does not include the crowns) then using the morphed model to build the full model (new shape including the crowns) and assign it to that stage. A palatal expander may then be built from this full stage.

FIGS. 5A and 5B show another view of a simulated expansion model of the upper palate. The original (starting) digital model of the upper jaw is shown in FIG. 5A; in FIG. 5B the left and right palatal regions (and associated/connected jaw/tooth regions) have been rotated about the expansion axis, resulting in expansions and opening of the midline suture 503 about an expansion angle 505.

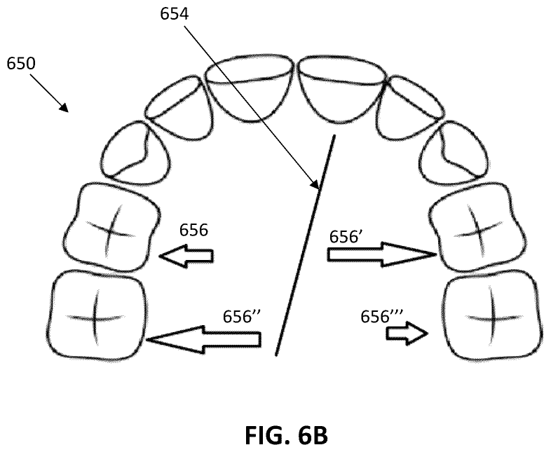

The expansion axis may be determined for a particular patient based on the actual location and orientation of the suture, e.g., as determined from the CBCT scan, and from one or more landmarks from the oral cavity (e.g., using digital model) and/or additional physiological markings from the patient. For example, the expansion axis may be determined for a particular patient by the anatomy of jaw and bone. The suture may be identified by a CBCT scan, and the expansion axis may be determined based on the suture (e.g., the location and/or orientation of the suture). For example, once the suture is identified, the expansion axis may be defined (e.g., prior to treatment and/or during treatment) such that it lies along a plane or line defined by the suture. In this example, when the suture is exactly along the sagittal midline of the patient, the expansion axis will lie along the mid-sagittal plane; when the suture is offset from the sagittal midline, the expansion axis will lie along a plane defined by the suture that is laterally offset and/or rotated with respect to the mid-sagittal plane. In some examples, as shown in FIG. 6A, the expansion axis may include a point, A, where the maxillary bone joints with front bone, and point, B, where maxillary bone joints with ethmoid bone. The expansion axis may be estimated from an average angle (e.g., between about 5 degrees 70 degrees, between about 5 degrees and 60 degrees, between about 5 degrees and 50 degrees, between about 5 degrees and 45 degrees, between about 5 degrees and 40 degrees, between about 10 degrees and 70 degrees, between about 10degrees and 60 degrees, between about 10 degrees and 50 degrees, between about 10 degrees and 40 degrees, between about 10 degrees and 45 degrees, etc.) relative to the xy plane (see xy plane illustrated in FIG. 3F). Although this disclosure focuses on using CBCT scans to identify topological information such as suture and bone features, the disclosure contemplates that any other suitable scanning technology may be used to determine topological information, and the methods and systems disclosed herein may be used with such other suitable scanning technology.

In some examples, e.g., where the suture is centrally located through the plane including the midline, only the arch-width and the palatal vault height may be used to calculate the Trans-Palatal-Arch (TPA) thickness, and constant values for the centers of expansion axes may be used to determine the staging patterns. The CBCT scan may permit customization of the TPA thickness/staging patterns which can optimize the palatal expander design for individual patients, as described herein.

In some examples, the skeletal lateral rotational axis (the expansion axis) may be defined by considering the natural rotation and bending of the skeletal bone structure when the expansion force is applied. Although in some examples a constant value may be used for the axis, based on a simplified model. However, in patients in which the location of the suture is offset from the midline/midplane, it may be particularly beneficial to also offset the axis of rotation. Additionally, a number of other axes need to be considered to further customize the device for each patient. Those axes may be determined based the anatomical information (e.g., topological information, biological information, material properties, etc.) of the individual patient.

The material properties (e.g. local Young's modulus) of the bone and soft tissue (e.g., sutures) might be estimated based on CBCT data as mentioned above, e.g., by calibrating a relationship between the tissue density and the gray scale with standards (e.g., phantoms), or one can simply use literature values. In some examples a machine learning model, such as a trained neural network, may be used to estimate the material properties based on other physiological information (e.g., age, gender, race, family history, medication, etc.) in addition to or instead of the CBCT grayscale information. Thus, the CBCT information, we may include the suture location, may be used to establish the rotational axes and achieve the optimum palatal expander device design at each stage.

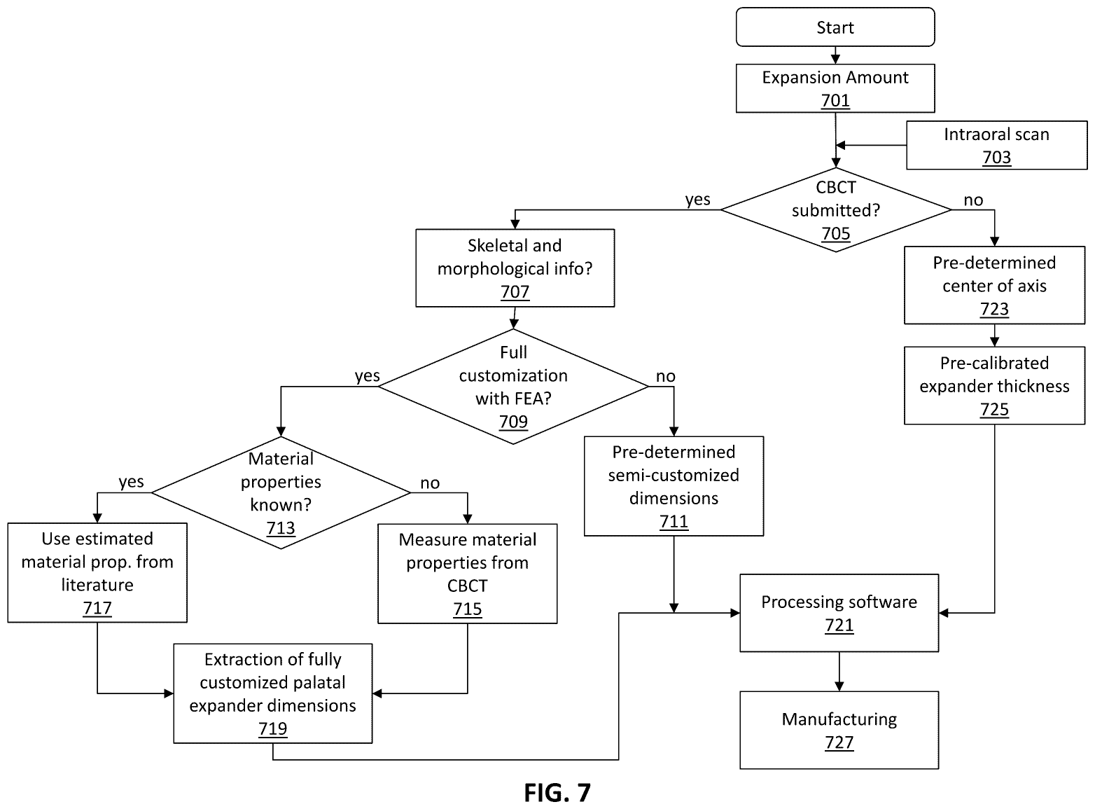

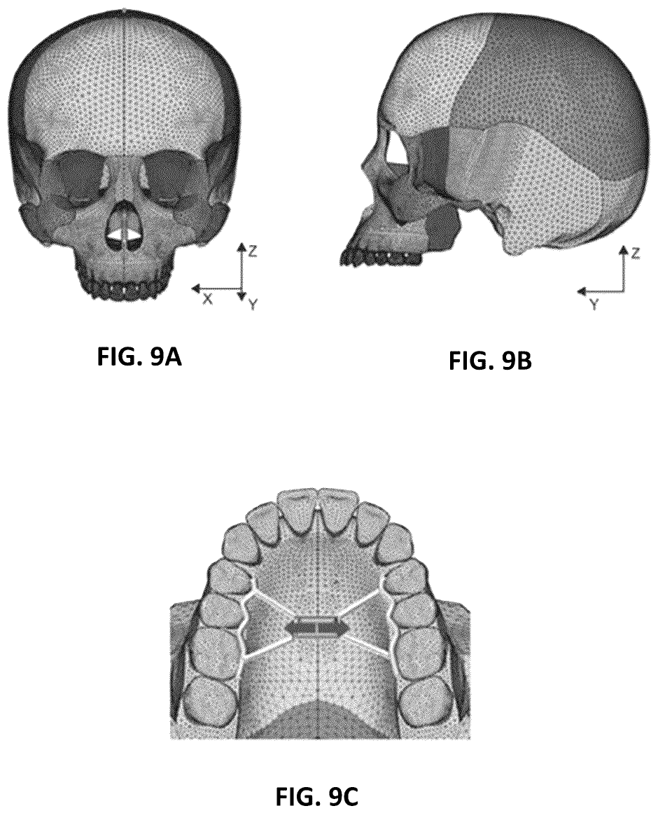

As described in FIG. 7, a simulation, e.g., a finite element analysis (FEA) simulation may be used to calculate more accurate expansion patterns with the topological information and the material properties. FIGS. 9A-9C and 10A-10C (adapted from Seong et al., “Evaluation of the effects of miniscrew incorporation in palatal expanders for young adults using finite element analysis,” The Korean Journal of Orthodontics 2018; 48 (2): 81-89, herein incorporated by reference in its entirety) illustrate one example of a finite element analysis examining palatal expansion. In FIGS. 9A-9C, a conventional rapid palatal expander (shown in FIG. 9C), which is attached to the teeth was used to generate the finite element analysis model. FIGS. 9A-9B show front and side views of a three-dimensional finite element model of a scull. FIGS. 10A-10C illustrate heat maps of the finite element model showing the von Mises stress distribution over the circumaxillary structures (g/mm2) caused by rapid palatal expansion (RPE) using the conventional (tooth-attached) palatal expander shown in FIG. 9C. FIG. 10A shows a frontal view, FIG. 10B shows a horizontal view and FIG. 10C shows the midpalatal suture.

As mentioned above, the target expansion force may be a constant value (e.g., 60 N, 40 N, etc.), and palatal expanders may be designed to provide the target expansion force. With the FEA the required expansion force may be calculated. In some examples, the FEA may also account for rotations, including tipping, by designing the palatal expander to provide a target moment that prevents the crowns from rotating beyond a maximum amount. As described in association with FIGS. 3D and 3E, unless specifically accounted for, palatal expansion causes some level of rotational movement along the coronal plane resulting in rotation of the dental arch (e.g., buccally). In addition, it forces on the teeth may cause the teeth themselves to rotate (e.g., tipping buccally). The disclosed systems and methods may use the FEA to design palatal expanders that provide target one or more moments calculated to control the rotation of the arch and/or teeth, or at least reduce such rotation to an acceptable level.

The methods and apparatuses (including software and palatal expanders) described herein may therefore control the rotation (e.g., tipping) of the crowns in a manner that is not readily achievable with previously described patient/caregiver removable palatal expanders in which outward rotation of the teeth cannot be accurately predicted and therefore controlled. In use, even palatal expanders designed to provide purely transverse expansion may result in rotation of the crowns due to compliance (i.e., lack of stiffness) in the device, and variations in patient anatomy. In contrast, the methods and apparatuses described herein may predict and control the patient-specific amount of rotation (including tipping) that allows for a balance of preventing tipping, which may be an ideal clinical outcome, and safety, which may permit tipping a similar amount to the maxilla to prevent dehiscence and/or fenestration. For example, although a preferred clinical outcome is to have teeth achieve an upright position, generally orthogonal to the jawline, for aesthetics and proper bite, this may not be the safest treatment outcome. For some patients, preventing or correcting tipping of teeth to achieve uprightness (particularly as the palate is expanded) can be a safety issue, resulting in dehiscence and/or fenestration, as described above. The incorporation of CBCT scan data, e.g., to determine material properties of the patient's jaw, such as the Young's modulus of local jaw regions and/or the actual position of the suture, allows more accurate prediction of the rotation and estimation of a target moment that best balances the desired clinical outcome with the safety.

In addition to preventing undesirable rotation (e.g., tipping) during palatal expansion, any of the methods and apparatuses described herein may correct the rotation of the patient's teeth that is already present, and not necessarily a result of the current palatal expansion. For example, a patient may already have teeth that are tipped lingually prior to palatal expansion, and tipping may be beneficial for aesthetics and proper bite. In such cases, the methods and apparatuses described herein may apply a target moment to tip the teeth buccally to a more upright position.

The target moment may be provided by shaping the palatal expander to add extra torque to the apical (top) portion of the tooth and/or to the gingiva. Alternatively or additionally, the target moment may be provided by designing the palatal expander to engage with active attachments on the tooth that apply a rotational force to rotate the crowns lingually. More information about rotation (including tipping) and target moments for palatal expander design can be found in U.S. Pat. No. 10,993,783, which is incorporated by reference herein in its entirety. Additionally, the location and balance of force across the molars can be tuned to achieve optimum expansion.

The target expansion velocity may be a current a constant value (0.25 mm/stage; 1 stage/day) or may be adjusted. For example, the finite element analysis (FEA) may indicate that a greater or lower velocity may be desired based on the outcome of the simulation. If the FEA results showed an excessive amount of local stress concentrations/strain concentrations, the expansion velocity can be adjusted downward to adjust the local stress/strain concentrations, and/or to set the number of stages required for treatment. In some examples, based on the results from the FEA, a range of expansion velocities may be determined, with an upper limit of the range corresponding to a maximum stress concentration/strain concentration for some or all local regions (e.g., one or more thresholds). This maximum may be a predetermined value, and may specify a velocity above which the stress concentration/strain concentration is unsafe or undesirable.

As discussed herein, the use of CBCT data may help to identify the physical palatal suture location and/or condition and this data may be factored in when defining the rotational axis. The physical palatal suture location and/or condition may also be included in subsequent treatment staging for a given case. For example, if the suture is not centered, but is offset left or right, then the method or apparatus may adjust its determination of the rotational axis accordingly. Thus, a personalized rotational axis may be determined for the patient based at least in part on the geometry, location, and/or orientation of the patient's palatal suture. This personalized axis (i.e., the rotational axis that is determined based on the actual suture of the patient) may be used to optimize the staging of the palatal expansion treatment. If the axis is offset from the sagittal plane, in some examples, variable and customized staging velocities may be applied toward different teeth and at customized angles (e.g., by changing the geometry and/or thickness of the palatal expander along different portions so as to achieve particular predetermined magnitude and direction of force vectors) to compensate in order to achieve a more ideal arch form. For example, the method or apparatus may be configured to apply a greater expansion velocity (e.g., by applying a greater force) away from the suture on regions that are closer to the suture as compared to region that are closer to the suture, as illustrated schematically in FIG. 6B. Thus, in general, a palatal expander for one or more stages may be configured so that the forces applied during one or more treatment stage may be different in the anterior posterior direction (e.g., the y axis in FIG. 3F) on either the left or right side (e.g., in the x axis of FIG. 3F) based on the relatively location of the suture as determined herein; these forces may be different (e.g., may vary) between different palatal expanders of a series of palatal expanders. In FIG. 6B the upper arch 650 is shown schematically, and illustrates an offset suture 654. In this example a palatal expander may be configured to apply different lateral (in the right/left or x axis directions) expansion forces depending on the relative minimum distances between the suture and the lateral sides of the arch (e.g., the premolars and molars), as illustrated by the arrows 656, 656′ and 656″, 656′″. The relative magnitudes of the lateral expansion forces is shown schematically by the relative sizes of the arrows. Greater lateral expansion forces (e.g., 656″, 656′) are applied where the actual suture region is more closely located relative to the suture 654, and lesser expansion forces (e.g., 656″′, 656) are applied where the suture if further from the edge of the upper arch. In FIG. 6B the arrows 656, 656′, 656″, 656′″ illustrate velocity/displacement. Thus, the forces applied may correlate to velocity/displacement. A palatal expander may be configured to apply a greater or lesser lateral displacement force (and therefore adjust the magnitude of the velocity of the displacement) by altering the relative shape of the corresponding region of the palatal expander and by increasing or decreasing the relative stiffness of that region of the palatal expander. The methods and apparatuses described herein may account for these differences in lateral forces/velocities in the design of the palatal expanders for each stage.

The staging of the palatal expansion may also be adjusted to account for a suture that is offset from the center (e.g., the sagittal axis) by increasing or decreasing the number of stages needed to expand the palate in comparison to treatments in which the suture is centered; in some cases additional stages may be needed as determined by the local stiffness (Young's modulus) of the palatal regions being acted upon by the palatal expanders. In any of these methods, the expansion force may be adjusted depending on the condition of the suture fibers (e.g., how loose/tight they are) to customize the treatment. Accurate/customized treatment may minimize unwanted contact, including interference between device and patient dentition.

The CBCT-aided IFPE design described herein may also be used to understand the position of the roots within the alveolar bone, which is advantageous in that it allows for the determination of a maximum amount of rotation of teeth (e.g., rotation from an active target moment applied to counter potential tipping of the teeth during expansion of the upper jaw along the expansion axis) before undesirable results occur. For example, the patient CBCT scan data may be used to determine the thickness of the buccal and lingual alveolar bone wall. Palatal expansion generally causes lateral movement of the posterior teeth, reducing the amount of alveolar bone between the roots and the lateral surface of the bone. In addition, as explained previously, palatal expansion causes rotation of the palate and the dental arch as described above with respect to FIG. 3C, which may cause teeth to be tipped buccally if not accounted for. In general, as previously explained, the disclosed palatal expanders may be configured to provide a target moment that counters at least some of this potential tipping. For patients with a thinner amount of bone in the jaw, the amount of expansion or the amount of rotation (e.g., tipping) may need to be reduced to reduce the risk of undesirable results such as fenestration or dehiscence. For example, the methods and apparatuses described herein may model, e.g., using a FEA, movement of the teeth, including rotation, highly accurately where the material properties of the tissue are known from the CBCT scan data, and may predict that if the proposed forces to be applied to the tissue will result in movement that causes undesirable issues such as root collisions, fenestrations, dehiscence, protrusions of teeth roots from alveolar bone, etc. In such cases, the forces and moments applied may be adjusted, for example, by adjusting local geometries of the palatal expander (e.g., shape at different regions of the palatal expander) and/or rigidities of different regions of the palatal expander (e.g., by varying thickness or materials at the different regions) to generate a final model of the palatal expander. In some embodiments, this may be an iterative process, where (a) local geometries and/or rigidities of the palatal expander are adjusted, (b) the predicted results are determined, (c) the predicted results are compared against predetermined standards/criteria to determine whether there may be undesirable issues, and repeating steps (a) through (c) until the comparison of step (c) results in no undesirable issues or at least results in a situation where undesirable issues are mitigated to an predetermined acceptable level. The adjusted forces may again be modeled to determine the likely movement of the teeth. In this manner the treatment plan and/or the palatal expander may be configured using the CBCT data to control rotation of the teeth. In some examples, generation of the final model in these examples may not require a generation of an initial model followed by an adjustment. In these examples, the final model may be generated directly by incorporating the CBCT scan data into the initial modeling process.

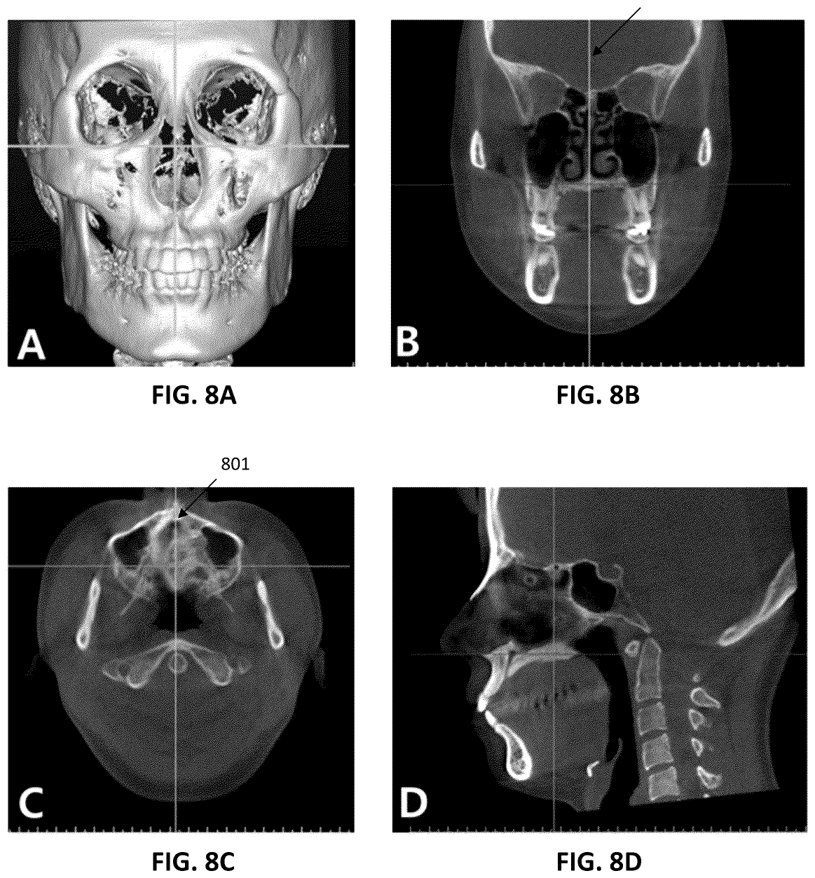

CBCT scan may be reoriented and measurements taken from them. For example, FIGS. 8A-8D (adapted from Chae et al., “A CBCT Evaluation of Midpalatal Bone Density in Various Skeletal Patterns,” Sensors 2021, 21 (23), 7812, herein incorporated by refence in its entirety) illustrates a cone-beam computed tomography (CBCT) image from which bone density measurements may be estimated. FIG. 8A illustrates reorientation of a CBCT scan orientated along the inferior border of the orbital rims in a frontal reconstructed view. FIG. 8B shows coronal and axial views. FIGS. 8A-8C are shown reoriented to allow for analysis at the midpalatal suture so that the vertical line 801 is positioned through the anterior nasal spine (ANS) to posterior nasal spine (PNS). FIG. 8D shows a sagittal view in which the CBCT image was rotated to confirm that the midpalatal line ran through ANS to PNS.

Another benefit of using CBCT scan data is the internal topological information on tooth root and alveolar bone, which may also be used for estimating forces and for determining optimal locations for attachment placement as well as other design considerations. For example, if a target moment to control rotation (e.g., tipping) is provided, the method and/or apparatus may include attachments close to the gingival margin. For cases where the target moment is not advisable, for example, where the bone is thinner and/or where teeth are retroclined and need to tip out to correct interdigitation of cusps on lower teeth, a larger margin may be included to avoid future engagement issues. The methods and apparatuses described herein may detect (from the CBCT data and/or the modeling described herein) cases where target moments to control rotation are not advisable and/or may prevent or may alert the user. In some examples attachment angle can be customized per patient depending on the magnitude and/or direction of the target moment to control rotation, and/or pre-existing tooth angle of the patient.

FIG. 7 illustrates one example of a method as described herein. In FIG. 7 the method may include initially determining the amount of palatal expansion to be applied 701. This data may be input from a user (e.g., doctor, dentist, orthodontist, technician, etc.). In some examples, the method or apparatus (e.g., system) may determine an expansion amount automatically or semi-automatically by deriving the target expansion based on intercuspation of upper and lower dentition.

The system may receive an intraoral digital surface scan of at least a portion of the intraoral cavity of a patient 703 (e.g., from an intraoral digital scanner). In some examples, the method and/or apparatus may optionally determine if a CBCT scan is available 705, e.g., by checking a database to which it has access. If no CBCT scan is available the system or method may proceed to presume central axes (e.g., expansion axis) 723, and may use a pre-set or predetermined thickness for the patient's transpalatal (TPA) region 725 in order to estimate a predicted rotation and translation of the left and right sides relative to a rotation axis. This information may be provided, for example, to an appliance design sub-system or module 721 configured to generate models (including initial, intermediate, and final models or stages) of palatal expansion (and expanders) as described herein, and one or more (e.g., a series) of palatal expanders may be fabricated based on the generated models 727 as described herein.

In some cases, where one or more CBCT scans is available, the system may then access the CBCT scan data and may identify internal topological information (e.g., skeletal and morphological information) 707. In some examples a module, e.g., which may include a machine learning agent trained to identify one or more internal features, such as the suture and/or tooth roots, etc., may be used to automatically identify the features. The CBCT scan may be segmented; in some examples the method may include segmenting the CBCT scan.

In some examples the method or apparatus may determine if material properties (e.g., stiffness) is to be detected from the CBCT scan, e.g., by determining if full customization and finite element analysis is to be used to model the palatal expansion 709. If not, then the apparatus and method may use predetermined, semi-customized dimensions 711. Alternatively, the method or apparatus may determine material properties, such as but not limited to stiffness (e.g., Young's modulus 713) from the CBCT scan. A sub-system or module may be used to determine one or more material properties from the CBCT scan. In some examples, the CBCT scan may be analyzed to determine an array of properties (e.g., values, such as Young's modulus) based on estimates from published (or otherwise predetermined) values. For example, material properties may be estimated from the grayscale values of the CBCT scan 715, as described above. In either case, the method or system may extract dimensions for the palatal expander 719 from the CBCT scan and may transmit these dimensions to the sub-system or module (e.g. processing software) 721 configured to generate intermediate models of palatal expansion. In some cases, when material properties cannot be accurately estimated from the CBCT scan, the method or apparatus may estimate all or some of the material properties from literature values 717, and provide these to the processing software 721. The resulting one or more (e.g., a series of) palatal expanders may be fabricated 727.

### Fabrication Methods

Once the series of palatal expanders has been planned, as described above, they may be fabricated; fabrication may be performed all at once or in batches (e.g., provided as a complete or partial set, such as days 1-4) or separately, and provided to the patient. Each expander may be marked to separately identify it, including marking to indicate a preferred order (e.g., first, second, etc.).

The palatal expanders described herein may be fabricated directly, for example by digitally designing the expander and fabricating the digital model using a 3D printer or other direct fabrication technique. Alternatively or additionally, the palatal expanders described herein may be fabricated indirectly, for example, using a physical model of the patient's dentation (e.g., a ceramic, plastic, plaster, etc. model), onto which materials are applied to form the palatal expander. Indirect fabrication methods may include lamination, in which the palatal expander is formed from laminated layers or portions. Indirect fabrication methods may also include direct fabrication of the model using a direct fabrication technique (e.g., 3D printing, etc.). Hybrid fabrication methods, in which a portion of the expander is directly fabricated, and then combined with additional elements (including layers or supports), with or without the use of a model of the patient's dentition, may also be used.

In any of the indirect fabrication techniques described herein, the expander may be formed on a physical model that has been adjusted (e.g., by moving palate) to a desired position on the way to the final expanded position. The physical model may include attachments (buttons, etc.) for coupling to attachments (e.g., trough-holes, etc.) on the expander, as discussed above.

When a physical model is used (either manually generated from impressions of a patient's teeth or from one or more digital models), the expander may be fabricated by molding a sheet of material over the model. In general any appropriate material may be used for the expander, as long as it is sufficiently biocompatible and possesses the rigidity and physical characteristics necessary (either on its own or in combination with other materials). For example, an expander may be formed of an acrylic material that is applied in a sheet over a physical model, formed (e.g., thermoformed, set) and then cut and/or trimmed. In various examples provided herein, the material may form (including set) by temperature and/or light or other appropriate means. For example, an expander may be formed of a thermoplastic curable polymer.

As discussed above, direct fabrication may be used to make any of the expanders described directly, using as input a digitally designed expander (e.g., a digital file specifying the geometry. Thus, these apparatuses may be formed without the need for a physical model of the patient's teeth/gingiva/palate. Direct fabrication may include 3D printing (SLA, DLP, volumetric) or additive manufacturing (e.g., extrusion type, light polymerization type, powder bed type, lamination type, powder fed type, etc.).

Any of the expanders described herein may be formed by one or more lamination processes in which multiple layers are sequentially or simultaneously attached together to form the expander. A lamination method may generally include using thermoplastic layers of various thicknesses and combining them to form various layers.

All publications and patent applications mentioned in this specification are herein incorporated by reference in their entirety to the same extent as if each individual publication or patent application was specifically and individually indicated to be incorporated by reference. Furthermore, it should be appreciated that all combinations of the foregoing concepts and additional concepts discussed in greater detail below (provided such concepts are not mutually inconsistent) are contemplated as being part of the inventive subject matter disclosed herein and may be used to achieve the benefits described herein.

Any of the methods (including user interfaces) described herein may be implemented as software, hardware or firmware, and may be described as a non-transitory computer-readable storage medium storing a set of instructions capable of being executed by a processor (e.g., computer, tablet, smartphone, etc.), that when executed by the processor causes the processor to control perform any of the steps, including but not limited to: displaying, communicating with the user, analyzing, modifying parameters (including timing, frequency, intensity, etc.), determining, alerting, or the like. For example, any of the methods described herein may be performed, at least in part, by an apparatus including one or more processors having a memory storing a non-transitory computer-readable storage medium storing a set of instructions for the processes(s) of the method.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

As described herein, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step.

In addition, one or more of the devices described herein may transform data, physical devices, and/or representations of physical devices from one form to another. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The processor as described herein can be configured to perform one or more steps of any method disclosed herein. Alternatively or in combination, the processor can be configured to combine one or more steps of one or more methods as disclosed herein.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under”, or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

In general, any of the apparatuses and methods described herein should be understood to be inclusive, but all or a sub-set of the components and/or steps may alternatively be exclusive and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that throughout the application, data is provided in a number of different formats, and that this data represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13,and 14 are also disclosed.

Although various illustrative embodiments are described above, any of a number of changes may be made to various embodiments without departing from the scope of the invention as described by the claims. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A method of forming one or more palatal expanders, the method comprising;
determining one or more material properties for one or more regions of a maxillary jaw from a cone-beam computed tomography (CBCT) scan of the maxillary jaw;
determining internal topological information for the maxillary jaw from the CBCT scan;
modeling expansion of a palatal region of the maxillary jaw from an initial position to an intermediate or final position using the one or more material properties for one or more regions of a maxillary jaw and the internal topological information, wherein a left maxillary portion of the maxillary jaw and a right maxillary portion of the maxillary jaw are progressively translated and rotated relative to their original positions; and
building one or more palatal expanders configured to achieve the final position using the modeled expansion of the palatal region of the maxillary jaw.

2. The method of claim 1, modeling comprises progressively translating and rotating the left maxillary portion of the maxillary jaw and the right maxillary portion of the maxillary jaw relative to their original positions about a location of a suture within the maxillary jaw determined from the internal topological information.

3. The method of claim 2, wherein the location of the suture within the maxillary jaw is offset from a midline of a palate of the maxillary jaw.

4. The method of claim 1, further comprising determining a target moment to tip the teeth buccally based on the one or more material properties and the modeled expansion of the palatal region of the maxillary jaw, wherein building the one or more palatal expanders comprises configuring the one or more palatal expanders to apply the target moment.

5. The method of claim 1, wherein building one or more palatal expanders comprises forming a series of palatal expanders configured to be worn in a sequence to expand the palatal region of the maxillary jaw from the initial position to the final position.

6. The method of claim 1, wherein modeling expansion of the palatal region of the maxillary jaw comprises using the material properties and the internal topological information in a finite element analysis model.

7. The method of claim 1, wherein the determining the one or more material properties comprises determining a local Young's modulus for a plurality of regions of the maxillary jaw from the CBCT scan of the maxillary jaw.

8. The method of claim 1, wherein the determining the one or more material properties comprises determining a local Young's modulus for a plurality of regions of the maxillary jaw from the CBCT scan of the maxillary jaw including a suture of the maxillary jaw.

9. The method of claim 1, wherein determining one or more material properties for one or more regions of the maxillary jaw from a CBCT scan comprises using a trained machine learning agent to determine the one or more material properties for the one or more regions of the maxillary jaw, wherein the machine learning agent is trained on CBCT scans having corresponding Young's moduli.

10. The method of claim 1, wherein determining one or more material properties for one or more regions of the maxillary jaw from a CBCT scan comprises applying a reference based on a density from the CBCT scan.

11. The method of claim 1, wherein determining internal topological information for the maxillary jaw from the CBCT scan comprises determining a location of a suture within the maxillary jaw.

12. The method of claim 11, wherein modeling expansion comprises modeling the left maxillary portion of the maxillary jaw and the right maxillary portion of the maxillary jaw progressively translating and rotating relative to their original positions with respect to a plane through the suture.

13. The method of claim 1, wherein determining internal topological information for the maxillary jaw from the CBCT scan comprises determining dimensions of alveolar bone within the maxillary jaw.

14.-15. (cancelled)

16. The method of claim 1, wherein modeling comprises dividing the expansion of the palatal region of the maxillary jaw from the initial position to the final position into a plurality of discrete stages and wherein building the one or more palatal expanders comprises building a palatal expander corresponding to one or more of these stages.

17. The method of claim 1, wherein modeling expansion of the palatal region comprises modeling the palatal region from an intraoral scan of the maxillary jaw.

18. The method of claim 1, wherein building the one or more palatal expanders comprises adjusting a thickness of a trans-palatal arch region of the one or more palatal expanders based on the modeled expansion of the palatal region in order to achieve the modeled expansion of the palatal region.

19. The method of claim 1, further comprising iterating the modeling step to minimize rotation of teeth within the maxillary jaw.

20. A method of forming one or more palatal expanders, the method comprising:
determining internal topological information for the maxillary jaw from a cone-beam computed tomography (CBCT) scan, wherein the internal topological information comprises the location of a suture within the maxillary jaw;
determining local Young's moduli for one or more regions of a maxillary jaw from a CBCT scan including the suture;
modeling expansion of a palatal region of the maxillary jaw from an initial position to a final position using the one or more material properties for the for one or more regions of a maxillary jaw and the internal topological information, wherein a left maxillary portion of the maxillary jaw and a right maxillary portion of the maxillary jaw are progressively translated and rotated relative to their original positions with respect to a plane through the suture;
building one or more palatal expanders configured to achieve the final position using the modeled expansion of the palatal region of the maxillary jaw.

21. A series of palatal expanders having a sequence and configured to be sequentially worn by a patient to expand the patient's palate the series of palatal expanders comprising,
for each palatal expander in the series:
a left tooth engagement region, a right tooth engagement region, and a palatal region between the left tooth engagement region and the right tooth engagement region,
wherein, for one or more palatal expanders in the series of palatal expanders, the left maxillary portion and the right maxillary portion are separated relative to each other relative to an expansion axis that is offset relative to a midline of the palatal region.

22. The series of palatal expanders of claim 21, wherein the expansion axis is determined based on internal topological information, the internal topological information determined based on a cone-beam computed tomography (CBCT) scan, an X-Ray scan, or a near infrared scan.

23.-28. (cancelled)
